(19) United States
(12) Patent Application Publication
(10) Pub. No.: US 2024/0159416 A1
(43) Pub. Date: May 16, 2024

(54) AIR DRYING SYSTEM AND METHOD OF CONTROLLING THE SAME

(71) Applicants: Samsung Display Co., LTD., Yongin-si (KR); KD ENS CO., LTD., Gimcheon-si (KR)

(72) Inventors: Ji Hoon CHOI, Yongin-si (KR); Jong Chan LEE, Yongin-si (KR); Hye Eul NOH, Yongin-si (KR)

(73) Assignees: Samsung Display Co., LTD., Yongin-si (KR); KD ENS CO., LTD., Gimcheon-si (KR)

(21) Appl. No.: 18/351,635

(22) Filed: Jul. 13, 2023

(30) Foreign Application Priority Data
Nov. 11, 2022 (KR) 10-2022-0150797

(51) Int. Cl. F24F 11/63; F24F 1/0083

(52) U.S. Cl. CPC F24F 11/63; F24F 1/0083

(57) ABSTRACT

An air drying system includes drying devices, each including an intake port and an exhaust port, measuring devices installed on respective exhaust pipes coupled to the exhaust ports of the drying devices, and measuring flow rates of air discharged from the drying devices, valves installed on the exhaust pipes to control the flow rates of air discharged from the drying devices, and a controlling device that receives data from the measuring devices, and controls the valves such that the flow rates of air discharged from the drying devices are uniform. The drying devices are controlled such that air is discharged from the drying devices at a uniform flow rate.

### CROSS-REFERENCE TO RELATED APPLICATION(S)

This application claims priority to and benefits of Korean patent application number 10-2022-0150797 under 35 U.S.C. § 119, filed on Nov. 11, 2022, in the Korean Intellectual Property Office (KIPO), the entire contents of which are incorporated herein by reference.

### BACKGROUND

### 1. Technical Field

The disclosure relates to an air drying system and a method of controlling the same.

### 2. Description of Related Art

Air for industrial use is generally used after removing water, dust, contaminants, and the like from the atmosphere air. Particularly, water may rust or corrode a mechanical apparatus, a semiconductor manufacturing apparatus, or the like, thus reducing the lifetime of the apparatus.

Therefore, air for industrial use is generally used after water has been removed from the air through a dehumidification process. Air drying systems may be installed to draw atmospheric air (or outer air) thereinto, remove water from the drawn air, and discharge air dried enough to be industrially used.

Air drying systems removes water from the atmospheric air with a method such as a freeze-dry method, an absorption method, or an adsorption method. An air drying system employing the adsorption method uses a porous adsorbent in a drying device to remove water from air. The adsorbent that has adsorbed water may be re-used by desorbing water therefrom.

The outer air that is drawn into the drying device and dried may continuously change in content of water in air depending on the temperature, the weather, the season, or the like. Because the content of water contained in the outer air may continuously change, an amount of water which is removed by the adsorbent may also be changed.

Consequently, a method of controlling the air drying system considering conditions of the outer air drawn into the air drying system is needed.

### SUMMARY

The disclosure is directed to an air drying system and a method of controlling the air drying system, in which drying devices are controlled such that air can be discharged from the drying devices at a uniform flow rate, so that a flow velocity of air discharged from each drying device can be reduced, whereby dehumidification efficiency of each drying device can be enhanced.

The disclosure is directed to an air drying system and a method of controlling the air drying system, in which the time for which an adsorption process is performed in the drying device can be variably controlled, considering conditions of the outer air.

The disclosure is directed to an air drying system and a method of controlling the air drying system, in which the drying device can be controlled such that sufficient dry air can be discharged from the drying device, considering conditions of air discharged from the drying device.

According to an embodiment of the disclosure, an air drying system may include a plurality of drying devices, each including an intake port that draws air into the plurality of drying devices, and an exhaust port that discharges air from the plurality of drying devices, a plurality of measuring devices, each installed on an exhaust pipe coupled to the exhaust port of each of the plurality of drying devices, the plurality of measuring devices measuring flow rates of air discharged from the plurality of drying devices, a plurality of valves, each installed on the exhaust pipe, the plurality of valves controlling the flow rates of air discharged from the plurality of drying devices, and a controlling device that receives data from the plurality of measuring devices, and controls the plurality of valves such that the flow rates of air discharged from the plurality of drying devices are uniform.

In case that a flow rate of air discharged from one of the plurality of drying devices is less than the flow rates of air discharged from another ones of the plurality of drying devices, the controlling device may control the plurality of valves to increase the flow rate of air discharged from the one of the plurality of drying devices.

In case that a flow rate of air discharged from one of the plurality of drying devices is greater than the flow rates of air discharged from another ones of the plurality of drying devices, the controlling device may control the plurality of valves to reduce the flow rate of air discharged from the one of the plurality of drying devices.

The controlling device may determine whether each of the plurality of drying devices has malfunctioned, based on the measured flow rates of air discharged from the plurality of drying devices.

In case that one of the plurality of drying devices is determined to have malfunctioned, the controlling device may close one of the plurality of valves that controls a flow rate of air discharged from the one of the plurality of valves.

The controlling device may increase opening degrees of another ones of the plurality of valves.

According to an embodiment of the disclosure, an air drying system may include an outer air inlet, a receiver tank that stores air drawn from the outer air inlet, a drying device including an intake port coupled to the receiver tank through an intake pipe, an exhaust port, a first tower, and a second tower, a first measuring device that measures at least one of a temperature of air drawn into the intake pipe, a relative humidity of air drawn into the intake pipe, and a pressure of air drawn into the intake pipe, and outputs an outer air conditioning signal including a measured value, and a controlling device that receives the outer air conditioning signal. An adsorbent may be disposed in each of the first tower and the second tower, one of the first tower and the second tower may perform an adsorption process of dehumidifying air drawn from the intake port and discharging dried air, another one of the first tower and the second tower may perform a regeneration process of desorbing water from the adsorbent, the exhaust port may discharge the dried air, and the controlling device may calculate a length of time for which the adsorption process is allowed to be continuously performed in the one of the first tower and the second tower.

The first measuring device may include a flow meter. The outer air conditioning signal may further include a flow rate of air flowing through the intake pipe.

The drying device may include a processor, and a system memory including a logic module executable by the processor. The logic module may calculate the length of time for which the adsorption process is allowed to be continuously performed in the one of the first tower and the second tower.

The outer air conditioning signal may further include the temperature of air drawn into the intake pipe, the relative humidity of air drawn into the intake pipe, and the pressure of air drawn into the intake pipe. The processor may calculate the length of time for which the adsorption process is allowed to be continuously performed, based on an absolute humidity of air drawn into the intake pipe calculated by a following Equation.

$${x}_{2} = 0.622 \frac{ϕ {P}_{S}}{P - ϕ {P}_{S}} \qquad Equation$$

In the Equation, x₂ may be the absolute humidity of air drawn into the intake pipe, P may be the pressure (hPa) of air drawn into the intake pipe, φ may be the relative humidity of air drawn into the intake pipe, and Ps may be a saturated vapor pressure based on the temperature of air drawn into the intake pipe.

The controlling device may include a first node that is electrically connected to the drying device and outputs a drying device control signal. In case that the length of time for which the adsorption process is allowed to be continuously performed has passed, the controlling device may output, to the first node, the drying device control signal to instruct to perform a tower switching process such that the regeneration process is performed in the one of the first tower and the second tower, and the adsorption process is performed in the another one of the first tower and the second tower.

The drying device may further include at least two drying devices. The controlling device may control the tower switching process to be performed among the at least two drying devices.

The drying device may further include a controller that controls a flow of air in the drying device in response to the drying device control signal.

The air drying system may further include a valve installed on an exhaust pipe coupled to the exhaust port, an inner air outlet that discharges air drawn into the exhaust pipe, and a second measuring device that measures at least one of a temperature of air drawn into the exhaust pipe, a relative humidity of air drawn into the exhaust pipe, and a pressure of air drawn into the exhaust pipe, and outputs an inner air conditioning signal including a measured value. The controlling device may receive the inner air conditioning signal, determine whether the drying device has malfunctioned, and control the adsorption process to be suspended in the drying device that is determined to have malfunctioned.

The controlling device may include a processor, and a system memory including a logic module executable by the processor. The logic module may compare the measured value included in the inner air conditioning signal with a preset value, and determine whether the drying device has malfunctioned based on the comparison.

The drying device may further include at least two drying devices. The controlling device may control, based on a pipe diameter of the intake pipe coupling each of the at least two drying devices to the receiver tank, opening degrees of the valve installed on the exhaust pipe of each of the at least two drying devices.

The length of time for which the adsorption process is allowed to be continuously performed may depend on at least one of the temperature of air drawn into the intake pipe, the relative humidity of air drawn into the intake pipe, and the pressure of air drawn into the intake pipe.

According to an embodiment of the disclosure, a method of controlling an air drying system including a plurality of drying devices may include drawing air into the plurality of drying devices, discharging the air from each of the plurality of drying devices, measuring a flow rate of air discharged from each of the plurality of drying devices, and controlling the flow rate of air discharged from each of the plurality of drying devices to be uniform, based on the measured flow rate of air discharged from each of the plurality of drying devices.

The controlling of the flow rate of air discharged from each of the plurality of drying devices to be uniform may include controlling opening degrees of a plurality of valves. Each of the plurality of valves may be installed on an exhaust pipe coupled to an exhaust port of each of the plurality of drying devices.

The method may further include determining whether each of the plurality of drying devices has malfunctioned based on the flow rate of air discharged from each of the plurality of drying devices. In case that one of the plurality of drying devices is determined to have malfunctioned, one of the plurality of valves installed on the exhaust pipe coupled to the exhaust port of the one of the plurality of drying devices may be closed, and opening degrees of another ones of the plurality of valves may be increased

### BRIEF DESCRIPTION OF THE DRAWINGS

FIG. 1 is a schematic diagram schematically illustrating an air drying system in accordance with embodiments of the disclosure.

FIG. 2 is a schematic system block diagram illustrating the air drying system in accordance with embodiments of the disclosure.

FIG. 3 is a schematic diagram illustrating a measuring device in accordance with embodiments of the disclosure.

FIG. 4 is a schematic diagram illustrating a receiver tank in accordance with embodiments of the disclosure.

FIGS. 5A to 5C are schematic diagrams illustrating a drying device in accordance with embodiments of the disclosure, and an adsorption process and a regeneration process which may be performed in the drying device.

FIG. 6 is a schematic system block diagram illustrating a controlling device in accordance with embodiments of the disclosure.

FIG. 7 is a schematic block diagram for describing an operation of setting a drying device control signal based on flow data of air, temperature data of air, and pressure data of air, in a method of controlling the air drying system in accordance with embodiments of the disclosure.

FIG. 8 is a schematic diagram illustrating an operation of controlling the drying device in response to the drying device control signal of FIG. 7.

FIG. 9 is a schematic block diagram illustrating the step of setting one or more of the drying device control signal and a valve control signal based on inner air conditions, in the method of controlling the air drying system in accordance with embodiments of the disclosure.

FIGS. 10A and 10B are schematic diagrams illustrating an operation of controlling the air drying system in response to the drying device control signal, the valve control signal, and the like in accordance with an embodiment of the disclosure.

FIG. 11 is a schematic diagram illustrating the step of controlling the air drying system based on the flow data in accordance with embodiments of the disclosure.

FIG. 12 is a schematic diagram illustrating the air drying system further including a compressing device in accordance with an embodiment of the disclosure.

### DETAILED DESCRIPTION OF THE EMBODIMENTS

Hereinafter, embodiments will be described in detail with reference to the attached drawings, such that those skilled in the art can readily implement the embodiments. The disclosure may be implemented in various forms, and is not limited to the embodiments to be described herein below.

In the drawings, portions which are not related to the disclosure will be omitted in order to explain the disclosure more clearly. Reference should be made to the drawings, in which similar reference numerals are used throughout the different drawings to designate similar components. Therefore, the aforementioned reference numerals may be used in other drawings.

For reference, the size of each component and the thicknesses of lines illustrating the component are arbitrarily represented for the sake of explanation, and the disclosure is not limited to what is illustrated in the drawings. In the drawings, the thicknesses of the components may be exaggerated to clearly depict multiple layers and areas.

Furthermore, the expression “being the same” may mean “being substantially the same”. In other words, the expression “being the same” may include a range that can be tolerated by those skilled in the art. Other expressions may also be expressions from which “substantially” has been omitted.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

For the purposes of this disclosure, “at least one of A and B” may be construed as A only, B only, or any combination of A and B. Also, “at least one of X, Y, and Z” and “at least one selected from the group consisting of X, Y, and Z” may be construed as X only, Y only, Z only, or any combination of two or more of X, Y, and Z. As used herein, the term “and/or” includes any and all combinations of one or more of the associated listed items.

Furthermore, embodiments of the disclosure are not limited to the illustrated embodiments. The drawings are provided only for illustrating embodiments of the disclosure. Embodiments of the disclosure may include embodiments in which at least some of components illustrated in the drawings are omitted.

It is also noted that, as used herein, the terms “substantially,” “approximately,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined or implied herein, all terms (including technical and scientific terms) used have the same meaning as commonly understood by those skilled in the art to which this disclosure pertains. It will be further understood that terms, such as those defined in commonly used dictionaries, should be interpreted as having a meaning that is consistent with their meaning in the context of the relevant art and should not be interpreted in an ideal or excessively formal sense unless clearly defined in the specification.

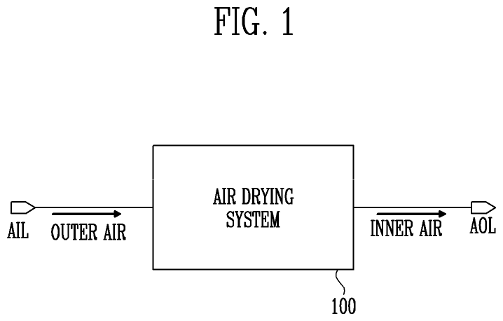

FIG. 1 is a schematic diagram schematically illustrating an air drying system 100 in accordance with embodiments of the disclosure.

Referring to FIG. 1, the air drying system 100 in accordance with embodiments of the disclosure may draw (or suck or suction) outer air thereinto, and discharge (or exhaust or send) inner air (or internal air) to outside.

The air drying system 100 in accordance with embodiments of the disclosure may include an outer air inlet AIL provided to draw outer air thereinto, and an inner air outlet AOL provided to discharge inner air to outside.

The air drying system 100 in accordance with embodiments of the disclosure may draw relatively humid air thereinto, dry the drawn air, and discharge the dry air to outside.

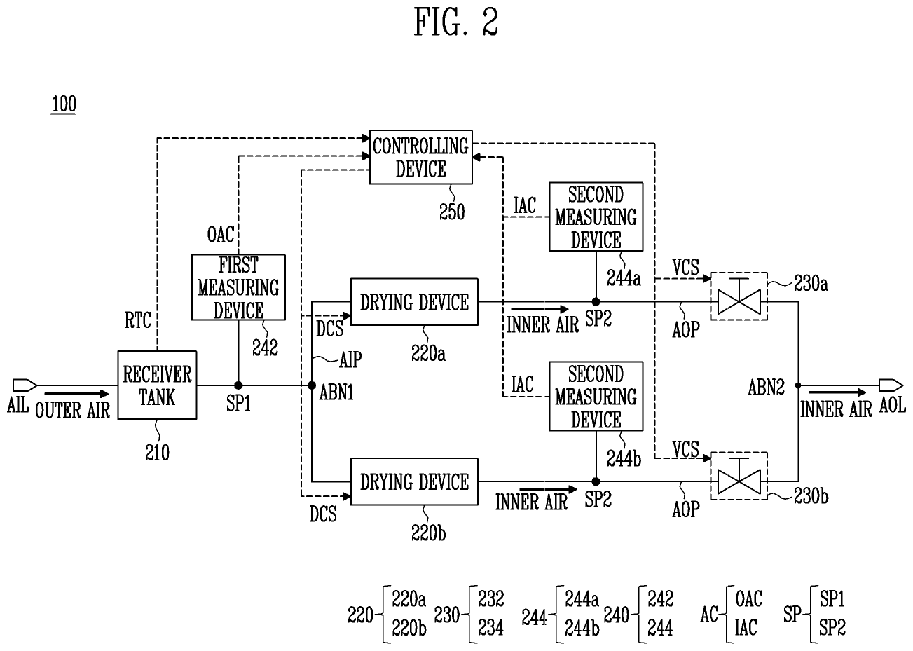

FIG. 2 is a schematic system block diagram illustrating the air drying system 100 in accordance with embodiments of the disclosure.

Referring to FIG. 2, the air drying system 100 in accordance with embodiments of the disclosure may include a receiver tank 210, a drying device 220, a valve 230, a measuring device 240, and a controlling device 250.

The receiver tank 210 may be configured to store outer air. Referring to FIG. 2, the receiver tank 210 may be coupled to the outer air inlet AIL. The receiver tank 210 may store outer air drawn from the outer air inlet AIL thereinto. The receiver tank 210 may be coupled to an intake pipe AIP. The air stored in the receiver tank 210 may be discharged to the drying device 220 through the intake pipe AIP.

The receiver tank 210 may output a receiver tank conditioning signal RTC including information about the temperature and/or pressure of the stored air. For example, the receiver tank 210 may include an air storage provided to store air therein. A receiver tank control signal RCT may include data about the temperature and/or pressure of air stored in the air storage. In embodiments, the receiver tank conditioning signal RTC may include data about the temperature and/or pressure of air to be discharged from the air storage. The receiver tank conditioning signal RTC may be inputted to the controlling device 250.

The drying device 220 may be coupled to the receiver tank 210 by the intake pipe AIP. The air drying system 100 in accordance with embodiments of the disclosure may include two or more drying devices 220a and 220b. The drying device 220 may dry air drawn thereinto through the intake pipe AIP, and discharge dry air through an exhaust pipe AOP.

The drying device 220 may perform an adsorption process and a regeneration process. The adsorption process may include a process of removing water from humid outer air using an adsorbent. The regeneration process may include a process of removing (or desorbing or eliminating) water from the adsorbent.

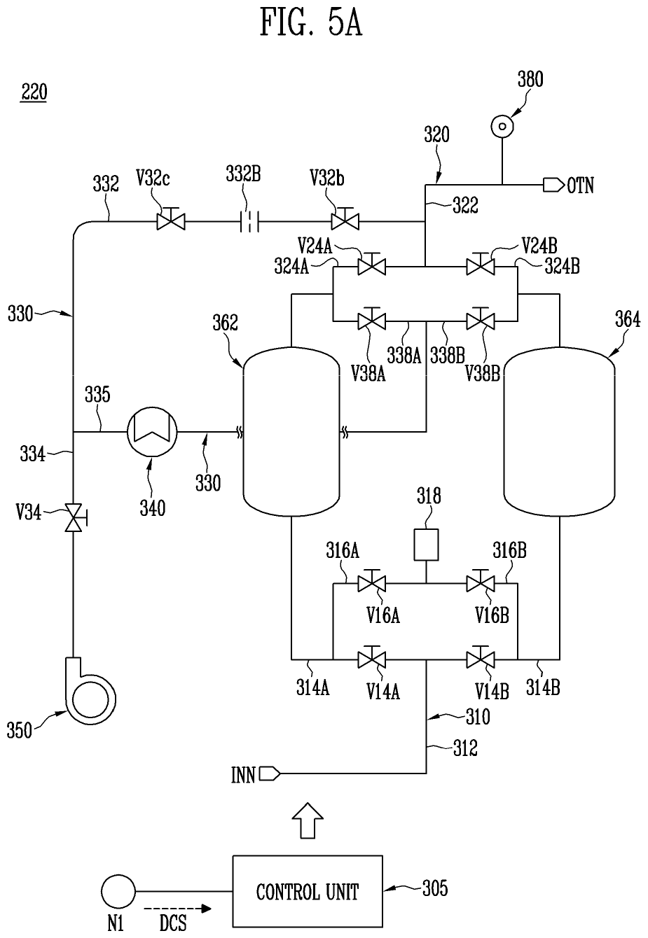

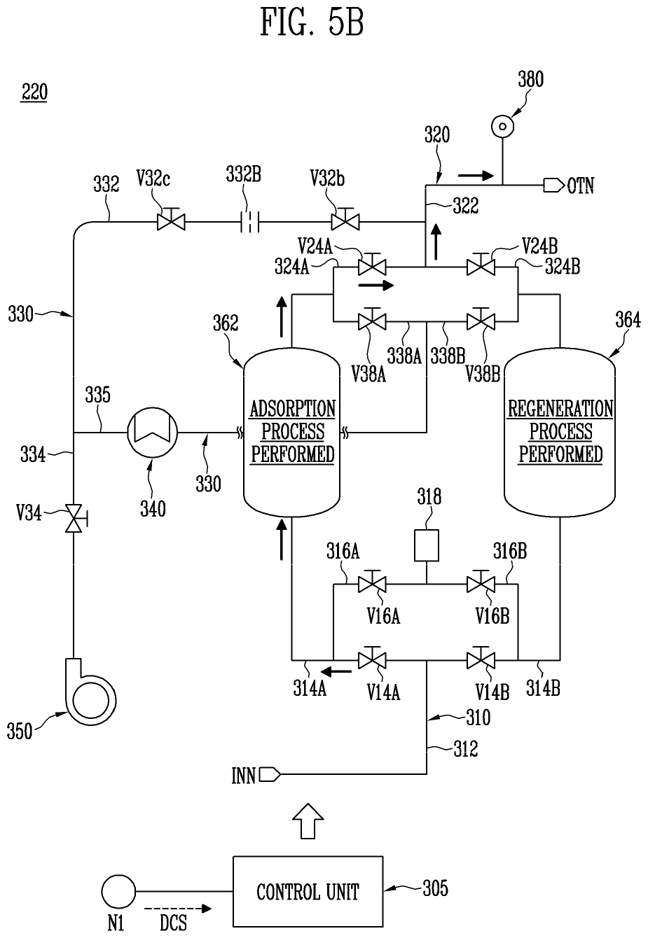

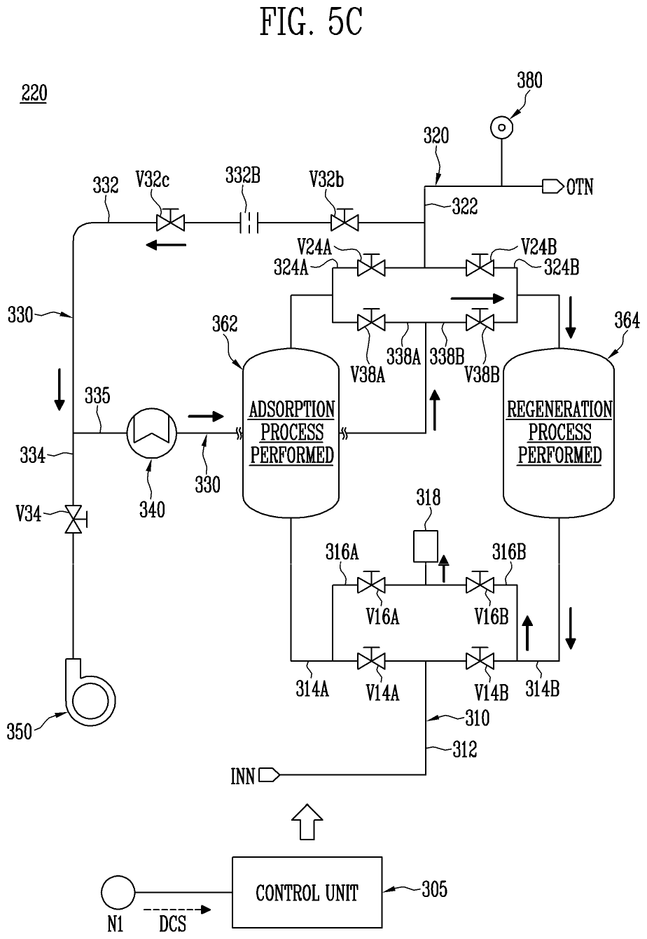

The drying device 220 may include a first tower (not illustrated) and a second tower (not illustrated). In an embodiment, the adsorption process may be performed in the first tower, and the regeneration process may be performed in the second tower. In an embodiment, the regeneration process may be performed in the first tower, and the adsorption process may be performed in the second tower. The configuration of the drying device will be described in detail with reference to FIGS. 5A to 5C.

The valve 230 may be installed in the exhaust pipe AOP. The valve 230 may be configured to control a flow rate of air to be discharged through the exhaust pipe AOP. For example, in case that the valve 230 completely opens, a relatively large amount of air may be discharged through the inner air outlet AOL. For example, in case that the valve 230 is completely closed, no air may be discharged through the exhaust pipe AOP. For example, in case that the valve 230 is partially closed (or partially opens), a relatively smaller amount of air may be drawn into the exhaust pipe AOP. The degree to which the valve 230 opens (or is closed) may also be referred to as “opening rate”. The degree to which the valve 230 opens may be controlled with an analog method (e.g., manually)or by a digital signal, depending on the embodiment.

Referring to FIG. 2, the air drying system 100 in accordance with embodiments of the disclosure may include two or more valves (e.g., a first valve 230a and a second valve 230b). For example, the valves 230a and 230b may be installed in the corresponding drying devices 220a and 220b.

The measuring device 240 may be configured to measure information (or data) pertaining to air flowing through the intake pipe AIP and/or the exhaust pipe AOP. Referring to FIG. 2, the measuring device 240 in accordance with embodiments of the disclosure may include a first measuring device 242 configured to measure the flow rate of air flowing through the intake pipe AIP, and a second measuring device 244 configured to measure the flow rate of air flowing through the exhaust pipe AOP.

The first measuring device 242 may be configured to measure information pertaining to air drawn into the intake pipe AIP. For example, the first measuring device 242 may measure at least one of the temperature of air drawn into the intake pipe AIP, the relative humidity of air drawn into the intake pipe AIP, and the pressure of air drawn into the intake pipe AIP. The first measuring device 242 may measure the flow rate of air drawn into the intake pipe AIP. The first measuring device 242 may measure the temperature, the relative humidity, the pressure, the flow rate, or the like of air at a first sampling point SP1 provided in the intake pipe AIP. The first measuring device 242 may output an outer air conditioning signal OAC including data about measured conditions of air (e.g., the temperature, the relative humidity, the pressure, the flow rate, or the like of air). The outputted outer air conditioning signal OAC may be inputted to the controlling device 250.

The second measuring device 244 may be configured to measure information pertaining to air flowing through the exhaust pipe AOP. For example, the second measuring device 244 may measure at least one of the temperature of air drawn into the exhaust pipe AOP, the relative humidity of air drawn into the exhaust pipe AOP, and the pressure of air drawn into the exhaust pipe AOP. The second measuring device 244 may measure the flow rate of air drawn into the exhaust pipe AOP. The second measuring device 244 may measure the temperature, the relative humidity, the pressure, the flow rate, or the like of air at a second sampling point SP2 provided in the exhaust pipe AOP. The air drying system 100 in accordance with embodiments of the disclosure may include two or more second measuring devices 244a and 244b. The second measuring device 244 may output an inner air conditioning signal IAC including data about measured conditions of air (e.g., the temperature, the relative humidity, the pressure, the flow rate, or the like of air). The outputted inner air conditioning signal IAC may be inputted to the controlling device 250.

Sampling points SP may include the first sampling point SP1 and the second sampling point SP2.

Although for convenience of explanation the first measuring device 242 and the second measuring device 244 are illustrated as being components provided separately from the drying device 220, the drying device 220 may include the first measuring device 242 and the second measuring device 244, depending on the embodiment.

The controlling device 250 may receive an air conditioning signal AC (e.g., an outer air conditioning signal OAC, or an inner air conditioning signal IAC) from the measuring device 240. The controlling device 250 may control the operation of at least one of the drying device 220 and the valve 230, based on the air conditioning signal AC inputted from the measuring device 240.

In some embodiments, the controlling device 250 may further receive a receiver tank conditioning signal RTC. The controlling device 250 may control the operation of at least one of the drying device 220 and the valve 230, based on the receiver tank conditioning signal RTC and the air conditioning signal AC.

The controlling device 250 may output a drying device control signal DCS for controlling the operation of the drying device 220, based on the outer air conditioning signal OAC inputted from the first measuring device 242. For example, the controlling device 250 may calculate the absolute humidity of the outer air, based on the outer air conditioning signal OAC inputted from the first measuring device 242. The controlling device 250 may calculate a length of time for which the adsorption process can be continuously performed in the drying device 220, based on the calculated absolute humidity of the outer air. The controlling device 250 may output, in case that the calculated time has passed, a drying device control signal DCS for selecting a tower, in which the adsorption process is performed, between the first tower and the second tower (e.g., a drying device control signal DCS for performing a tower switching process).

The controlling device 250 may output at least one of a drying device control signal DCS and a valve control signal VCS, based on the inner air conditioning signal IAC inputted from the second measuring device 244.

The drying device control signal DCS may include a signal to instruct the adsorption process to be suspended. For example, the drying device 220 may suspend the adsorption process in response to the drying device control signal DCS. Hence, air (e.g., dry air) may not be discharged from the drying device 220, and air may not be drawn into the exhaust pipe AOP.

The valve control signal VCS may include a signal for controlling the degree to which the valve 230 opens (or is closed). For example, the valve control signal VCS may include a signal to instruct the valve 230 to completely open, or a signal to instruct the valve 230 to be completely closed. The valve control signal VCS may include a signal to instruct the valve 230 to partially open (or be partially closed).

The controlling device 250 may calculate the absolute humidity of the inner air, based on the inner air conditioning signal IAC inputted from the second measuring device 244. The controlling device 250 may determine whether the drying device 220 has malfunctioned, based on the calculated absolute humidity of the inner air.

For example, the controlling device 250 may output a drying device control signal DCS to instruct the adsorption process of the drying device 220 that is determined to have malfunctioned to be suspended. For example, to prevent air from being discharged from the drying device 220 that is determined to have malfunctioned, the controlling device 250 may output a valve control signal VCS to completely close the valve 230 coupled to the corresponding drying device 220.

The controlling device 250 may control, based on the inner air conditioning signal IAC, the opening rates of the valves 230 so that the flow rates of inner air discharged from the drying devices 220a and 220b can be uniform (e.g., such that the flow rates are the same as each other, or the flow rates are substantially the same as each other, considering a margin of error). In an embodiment, the controlling device 250 may control the opening rate of the valve 230 based solely on the flow data of inner air that is inputted from the second measuring device 244, without separately considering the absolute humidity of the outer air, the absolute humidity of the inner air, or the like. For example, to increase the flow rate of air discharged from the drying device 220 that has a relatively low discharge air flow rate, the controlling device 250 may increase the opening rate of the valve 230 coupled to the corresponding drying device 220. For example, to reduce the flow rate of air discharged from the drying device 220 that has a relatively high discharge air flow rate, the controlling device 250 may reduce the opening rate of the valve 230 coupled to the corresponding drying device 220.

In case that the air drying system 100 in accordance with embodiments of the disclosure includes two or more drying devices 220a and 220b, the intake pipe AIP may include a first branch node ABN1. The intake pipe AIP may branch at the first branch node ABN1.

In case that the air drying system 100 in accordance with embodiments of the disclosure includes two or more drying devices 220a and 220b, the exhaust pipe AOP may include a second branch node ABN2. The exhaust pipe AOP may be joined at the second branch node ABN2.

The air drying system 100 in accordance with embodiments of the disclosure may calculate a period during which the adsorption process can be continuously performed in the drying device 220, depending on the absolute humidity of the outer air. The time for which the adsorption process is continuously performed in the drying device 220 may be controlled depending on the calculated period.

The air drying system 100 in accordance with embodiments of the disclosure may determine whether each drying device 220 has malfunctioned depending on the absolute humidity of inner air. For example, the air drying system 100 in accordance with embodiments of the disclosure may control the drying devices 220 such that one of the drying devices 220 that has malfunctioned stop performing an adsorption process, and another one of the drying devices 220 performs an adsorption process.

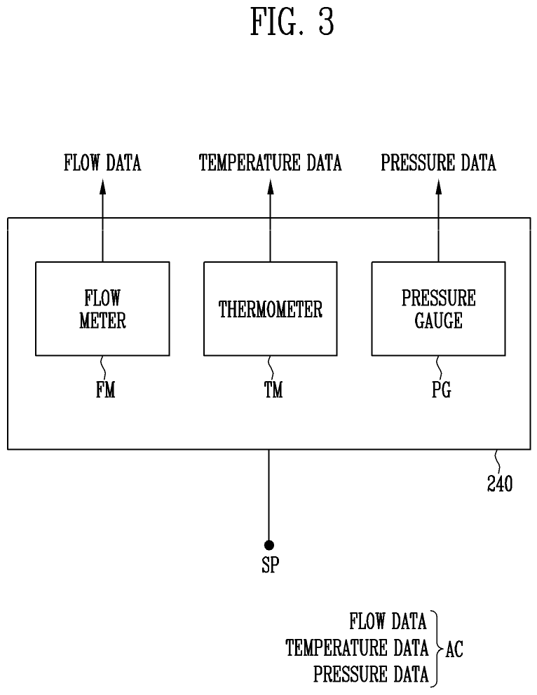

FIG. 3 is a schematic diagram illustrating the measuring device 240 in accordance with embodiments of the disclosure.

Referring to FIG. 3, the measuring device 240 may be configured to measure one or more of the flow rate of air, the temperature of air, and the pressure of air at the sampling point SP.

The measuring device 240 in accordance with embodiments of the disclosure may include at least one of a flow meter FM, a thermometer TM, and a pressure gauge PG.

The flow meter FM may be configured to measure (e.g., gauge) the flow rate of air at the sampling point SP. The thermometer TM may be configured to measure (e.g., gauge) the temperature of air at the sampling point SP. The pressure gauge PG may be configured to measure (e.g., gauge) the pressure of air at the sampling point SP.

The flow meter FM, the thermometer TM, and the pressure gauge PG may be embodied by any technique, and are not limited.

The measuring device 240 may output an air drying signal AC. The air drying signal AC may include one or more of flow data FLOW DATA, temperature data TEMPERATURE DATA, and pressure data PRESSURE DATA, depending on components included in the measuring device 240.

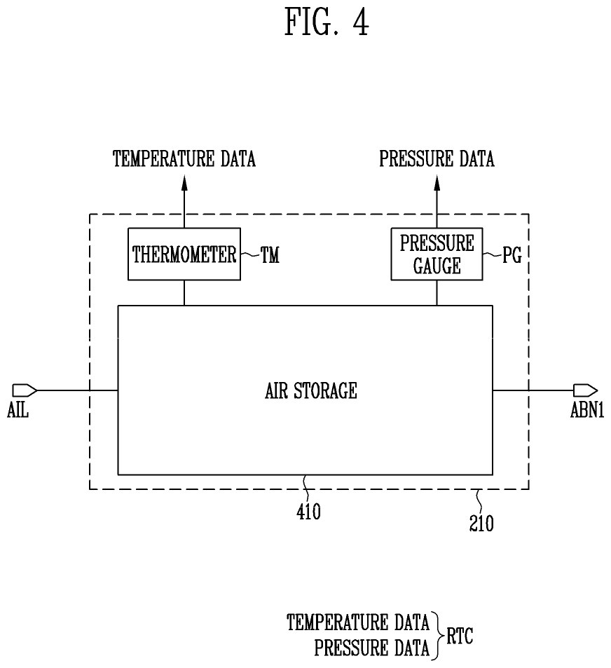

FIG. 4 is a schematic diagram illustrating the receiver tank 210 in accordance with embodiments of the disclosure.

Referring to FIG. 4, the receiver tank 210 in accordance with embodiments of the disclosure may include an air storage 410.

The air storage 410 may be coupled to an outer air inlet AIL. The air storage 410 may be connected to the first branch node ABN1. The air storage 410 may store air drawn from the outer air inlet AIL. The stored air may be discharged through the first branch node ABN1.

Referring to FIG. 4, in an embodiment, the receiver tank 210 in accordance with embodiments of the disclosure may include a thermometer TM and/or a pressure gauge PG.

The thermometer TM may measure (e.g., gauge) the temperature of air stored in the air storage 410. The pressure gauge PG may measure (e.g., gauge) the pressure of air stored in the air storage 410.

In an embodiment, the thermometer TM may be installed on a pipe line that connects the air storage 410 and the first branch node ABN1. In an embodiment, the pressure gauge PG may be installed on the pipe line that connects the air storage 410 and the first branch node ABN .

Referring to FIG. 4, the receiver tank 210 may output a receiver tank conditioning signal RTC. The receiver tank conditioning signal RTC may include temperature data TEMPERATURE DATA of air and/or pressure data PRESSURE DATA of air, depending on components included in the receiver tank 210.

In an embodiment, one of the receiver tank conditioning signal RTC and the outer air conditioning signal OAC (refer to FIG. 2) may include a temperature data TEMPERATURE DATA of air. In an embodiment, one of the receiver tank conditioning signal RTC and the outer air conditioning signal OAC (refer to FIG. 2) may include a pressure data PRESSURE DATA of air.

In an embodiment, in case that the receiver tank 210 includes the thermometer TM and the pressure gauge PG, the first measuring device 242 (refer to FIG. 2) may include only the flow meter FM (refer to FIG. 3).

In an embodiment, in case that the receiver tank 210 includes one of the thermometer TM and the pressure gauge PG, the first measuring device 242 (refer to FIG. 2) may include another one of the thermometer TM and the pressure gauge PG, and the flow meter FM (refer to FIG. 3).

In an embodiment, in case that the receiver tank 210 includes neither the thermometer TM nor the pressure gauge PG, the first measuring device 242 (refer to FIG. 2) may include the thermometer TM, the pressure gauge PG, and the flow meter FM (refer to FIG. 3). In the embodiment, the receiver tank 210 may not output a receiver tank conditioning signal RTC.

FIGS. 5A to 5C are schematic diagrams illustrating the drying device 220 in accordance with embodiments of the disclosure, and an adsorption process and a regeneration process which may be performed in the drying device 220.

Referring to FIGS. 5A to 5C, the drying device 220 in accordance with embodiments of the disclosure may include an inlet line 310, an outlet line 320, a regeneration line 330, a heater 340, a first tower 362, a second tower 364, and the like.

The drying device 220 in accordance with embodiments of the disclosure may include multiple valves V14A, V14B, V16A, V16B, V24A, V24B, V32b, V32c, V34, V38A, V38B, and the like provided to control a flow of air in each line 310, 320, or 330. The drying device 220 in accordance with embodiments of the disclosure may include an outer air supply unit 350 configured to supply outer air. The drying device 220 in accordance with embodiments of the disclosure may include a dew point meter 380 configured to measure the dew point of dry air.

The drying device 220 in accordance with embodiments of the disclosure may include a control unit 305 configured to control the operation of valves of the drying device 220, an operating time of each of the first tower 362 and the second tower 364, and a tower switching operation between the first tower 362 and the second tower 364.

The drying device 220 in accordance with embodiments of the disclosure may include an intake node INN through which outer air is drawn, and an exhaust node OTN through which dry air is discharged. The intake node INN may include, for example, the intake pipe AIP (refer to FIG. 2) described above. The exhaust node OTN may include, for example, the exhaust pipe AOP (refer to FIG. 2) described above. The pressure of air drawn into the intake node INN and the outer air supply unit 350 may be the same or different from each other. For example, compressed air formed by an air compressor (not illustrated) or the like may be drawn into the intake node INN. For example, outer air of atmospheric pressure may be drawn into the outer air supply unit 350.

In the drying device 220 in accordance with embodiments of the disclosure, outer air which is a target to be dehumidified may be air that contains water, and the kind of air is particularly limited.

An adsorbent may be disposed in each of the first tower 362 and the second tower 364. For example, an adsorbent may be filled in the first tower 362 and the second tower 364. One of the first tower 362 and the second tower 364 may perform an adsorption process (or referred to as a dehumidification process) for removing water from outer air. Another one of the first tower 362 and the second tower 364 may perform a regeneration process for removing water from the adsorbent provided therein. A tower switching operation may be performed so that the one of the first tower 362 and the second tower 364 performs a regeneration process, and the another one of the first tower 362 and the second tower 364 performs an adsorption process.

The adsorbent may include a material capable of adsorbing water contained in outer air. For example, the adsorbent may include at least one of alumina, silica, alumina-silica, and molecular sieves, but the disclosure is not limited thereto. The adsorbent may be provided in the form of beads, pellets, and/or flakes, but the disclosure is not limited thereto.

The inlet line 310 may be configured to draw outer air thereinto and supply the outer air to the first tower 362 and/or the second tower 364. The inlet line 310 may include, for example, a main inlet pipe 312 coupled to the intake node INN or the like, and a first branch inlet pipe 314A and a second branch inlet pipe 314B which are branched from the main inlet pipe 312. The first branch inlet pipe 314A may be coupled to the first tower 362. The second branch inlet pipe 314B may be coupled to the second tower 364.

Inlet valves V14A and V14B may be installed on the inlet line 310 to control the inlet line 310. For example, the inlet valves V14A and V14B may open or close the inlet line 310. The first inlet valve V14A may be installed on the first branch inlet pipe 314A. The second inlet valve V14B may be installed on the second branch inlet pipe 314B. For example, in case that the first tower 362 performs an adsorption process and the second tower 364 performs a regeneration process, the first inlet valve V14A may open, and the second inlet valve V14B may be closed.

Referring to FIG. 5A, the drying device 220 may include a first purging pipe 316A and a second purging pipe 316B. The first purging pipe 316A and the second purging pipe 316B may be configured to discharge regeneration gas to the outside. The first purging pipe 316A and the second purging pipe 316B may be coupled to the inlet line 310. The first purging pipe 316A may be coupled to the first branch inlet pipe 314A in such a way that the first purging pipe 316A is branched from the first branch inlet pipe 314A. The second purging pipe 316B may be coupled to the second branch inlet pipe 314B in such a way that the second purging pipe 316B is branched from the second branch inlet pipe 314B. A first purging valve V16A may be installed on the first purging pipe 316A. A second purging valve V16B may be installed on the second purging pipe 316B.

The drying device 220 in accordance with embodiments of the disclosure may further include a silencer 318 configured to reduce noise generated in case that regeneration gas is discharged to the outside. For example, the silencer 318 may be coupled to the first purging pipe 316A and the second purging pipe 316B and function to reduce the flow rate of regeneration gas discharged out of the first purging pipe 316A and/or the second purging pipe 316B, thus mitigating noise.

The outlet line 320 may be configured to discharge dry air dehumidified by the first tower 362 or the second tower 364. The outlet line 320 may include a first branch discharge pipe 324A through which dry air dehumidified by the first tower 362 is discharged, a second branch pipe 324B through which dry air dehumidified by the second tower 364, and a main discharge pipe 322 to which the first branch discharge pipe 324A and the second branch pipe 324B are joined.

A first discharge valve V24A may be installed on the first branch discharge pipe 324A. A second discharge valve V24B may be installed on the second branch discharge pipe 324B. For example, in case that the first tower 362 performs an adsorption process and the second tower 364 performs a regeneration process, the first discharge valve V24A may open, and the second discharge valve V24B may be closed.

The regeneration line 330 may be configured to draw regeneration gas thereinto and supply the regeneration gas to the first tower 362 and/or the second tower 364. For example, the regeneration line 330 may be configured to supply regeneration gas to one of the first and second towers 362 and 364 that performs a regeneration process.

The regeneration gas may include, for example, outer air and dry air dehumidified in one of the first and second towers 362 and 364 that performs an adsorption process. Referring to FIG. 5A, the regeneration line 330 may include at least one of a dry air inlet pipe 332 and an outer air inlet pipe 334.

The regeneration line 330 may include the inlet pipes 332 and 334 provided to drawn the regeneration gas such as dry air and outer air, and supply pipes 338A and 338B provided to supply the regeneration gas drawn from the inlet pipes 332 and 334 to one of the first tower 362 and the second tower 364.

The first supply pipe 338A may be configured to supply regeneration gas to the first tower 362. The second supply pipe 338B may be configured to supply regeneration gas to the second tower 364. A first regeneration valve V38A and a second regeneration valve V38B may be respectively installed on the first supply pipe 338A and the second supply pipe 338B. For example, in case that the first tower 362 performs an adsorption process and the second tower 364 performs a regeneration process, the first regeneration valve V38A may be closed, and the second regeneration valve V38B may open.

Referring to FIG. 5A, the regeneration line 330 may include both of the dry air inlet pipe 332 and the outer air inlet pipe 334. The regeneration line 330 may include a regeneration confluent pipe 335 to which the dry air inlet pipe 332 and the outer air inlet pipe 334 are joined. The regeneration confluent pipe 335 may be coupled to the supply pipes 338A and 338B.

The dry air inlet pipe 332 may be coupled to the outlet line 320. The dry air inlet pipe 332 may be configured to draw some of dry air dehumidified by the first tower 362 or the second tower 364. A flow control valve V32b, an orifice 332B, a reducing valve V32c, and/or the like may be installed on the dry air inlet pipe 332.

The flow control value V32b may control the flow rate of dry air drawn from the outlet line 320.

The orifice 332B may control the flow rate of dry air and adiabatically expand the dry air.

The reducing valve V32c may reduce the pressure of the dry air.

The dry air passing through the dry air inlet pipe 332 may be maintained at an appropriate flow rate and an appropriate pressure by the flow control valve V32b, the orifice 332B, the reducing valve V32c, and/or the like. For example, approximately 8% to approximately 20% of air discharged to the outlet line 320 may be drawn into the dry air inlet pipe 332 by the flow control valve V32b. Furthermore, for example, in case that one (e.g., the second tower 364) of the first and second towers 362 and 364 performing a regeneration process is driven at a driving pressure of about 7.0 kg/cm2, dry air passing through the dry air inlet pipe 332 may be maintained at a pressure in a range of about 1.0 kg/cm2 to about 3.0 kg/cm2.

The outer air inlet pipe 334 may be configured to draw outer air into the drying device 220. The outer air supply unit 350 may be connected to the outer air inlet pipe 334. According to an embodiment, the outer air supply unit 350 may include, for example, a blower, a fan, or the like provided to draw air from the atmosphere and supply the air into the outer air inlet pipe 334, but the disclosure is not limited thereto. An outer air valve V34 for controlling the flow of outer air may be installed on the outer air inlet pipe 334.

The heater 340 may heat regeneration gas. According to an embodiment, the heater 340 may include a unit such as an electric heater and/or a steam heater capable of heating gas, but the disclosure is not limited thereto. The heater 340 may be installed on the regeneration line 330. For example, the hater 340 may be installed on the regeneration confluent pipe 335.

The dew point meter 380 may be configured to measure the dew point of dry air. The dew point meter 380 may sample dry air discharged from the outlet line 320, and measure the dew point of the sampled dry air. In an embodiment, the dew point meter 380 may be coupled to and installed on the outlet line 320. The dew point meter 380 may measure an amount of water contained in the sampled dry air, and output a numerical value of the measured result as a unit of a dew point (e.g., −40° C.).

The control unit 305 may control the operation or the like of the drying device 220. The control unit 305 may include components used in this art and also in general industrial fields such as a machine equipment field and an electronic equipment field. For example, the control unit 305 may include a sensor, a timer, a controller, a display device, and the like. The controller may include a programmable logic controller (PLC) and/or a printed circuit board (PCB). The control unit 305 may control the opening and closing of the valves V14A, V14B, V16A, V16B, V24A, V24B, V32b, V32c, V34, V38A, V38B, and the like installed on the lines 310, 320, and 330, the operating time of each of the first tower 362 and the second tower 364, a tower switching operation between the first tower 362 and the second tower 364, and the like.

The control unit 305 may receive a drying device control signal DCS. The control unit 305 may perform the foregoing control operation based on the inputted drying device control signal DCS. The control unit 305 may include a first node N1 provided to receive the drying device control signal DCS.

The drying device control signal DCS may be determined based on at least one of the temperature, the relative humidity, and the pressure of outer air drawn into the drying device 220. According to the foregoing, the length of time for which the adsorption process is continuously performed may be controlled based on at least one of the temperature, the relative humidity, and the pressure of the outer air (e.g., air drawn into an intake port INN of the drying device 220). For example, the length of time for which the adsorption process is continuously performed may be controlled based on the absolute humidity of the outer air.

In the drying device 220 in accordance with embodiments of the disclosure, in case that the temperature of the outer air is comparatively high, the relative humidity of the outer air is comparatively high, or the pressure of the outer air is comparatively low (e.g., the absolute humidity is comparatively high), the time for which the adsorption process is performed may be reduced. In case that the temperature of the outer air is comparatively low, the relative humidity of the outer air is comparatively low, or the pressure of the outer air is comparatively high (e.g., the absolute humidity is comparatively low), the time for which the adsorption process is performed may be increased.

In accordance with embodiments of the disclosure, in case that the flow rate of air (e.g., atmospheric air, or air compressed to a high pressure by a compressor or the like) drawn into the intake port INN is constant, the length of time for which the adsorption process is continuously performed may be controlled considering one or more factors (e.g., the temperature of the outer air, the relative humidity of the outer air, and the pressure of the outer air) which may affect the absolute humidity.

In another embodiment, the drying device control signal DCS may be determined based on at least one of the temperature, the relative humidity, and the pressure of inner air to be exhausted from the drying device 220. According to the foregoing, whether the drying device 200 has malfunctioned may be determined, based on one or more of the temperature, the relative humidity, and the pressure of inner air (e.g., air to be exhausted from an exhaust port OTN of the drying device 220). Based on a result of determining whether the drying device 200 has malfunctioned, it may be determined whether to suspend the adsorption process.

In accordance with embodiments of the disclosure, it may be determined whether the drying device 220 has malfunctioned based on one or more of factors (e.g., the temperature of the inner air, the relative humidity of the inner air, and the pressure of the inner air) which may affect the absolute humidity of air exhausted from the exhaust port OTN.

In an embodiment, the drying device 220 may include the first measuring device 242 (refer to FIG. 2) coupled to the intake port INN. In an embodiment, the drying device 220 may include the second measuring device 244 (refer to FIG. 2) coupled to the exhaust port OTN.

The drying device 220 in accordance with embodiments of the disclosure may further include a filter (not illustrated). The filter may be installed on an inlet and/or an outlet of the first tower 362. The filter may be installed on an inlet and/or an outlet of the second tower 364. The filter may function to filter out foreign substances (solid bodies) from outer air or inner air. The filter may be installed on at least one of the inlet line 310 and the outlet line 320. In an embodiment, the drying device 220 may include an inlet filter installed on the inlet line 310, and an outlet filter installed on the outlet line 320.

FIG. 5B is a schematic diagram illustrating the flow of air during an adsorption process in the drying device 220 in accordance with embodiments of the disclosure. FIG. 5C is a schematic diagram illustrating the flow of air during a regeneration process in the drying device 220 in accordance with embodiments of the disclosure.

### [1] Adsorption Process

FIG. 5B illustrates that an adsorption process is performed in the first tower 362, and a regeneration process is performed in the second tower 364.

Referring to FIG. 5B, the adsorption process may be performed in the first tower 362, and the regeneration process may be performed in the second tower 364 during at least a portion of a period which the adsorption process is performed in the first tower 362.

Outer air may be drawn into the first tower 362 through the inlet line 310. The outer air may be drawn into the first tower 362 through the main inlet pipe 312 and the first branch inlet pipe 314A. The first inlet valve V14A may open, and the second inlet valve V14B may be closed.

The outer air may be drawn into the first tower 362, and may be dehumidified (dried) by the adsorbent with which the first tower 362 is filled. The dry air dehumidified to a certain dew point may be discharged through the outlet line 320. The dry air discharged through the outlet line 320 may be discharged out of the air drying system 100 (refer to FIG. 1). The air discharged out of the air drying system 100 (refer to FIG. 1) may be, for example, stored in a storage tank or supplied to an air header or the like to allow the air to be used in equipment in each site.

### [2] Regeneration Process

Referring to FIG. 5C, during at least a portion of the period which the adsorption process is performed in the first tower 362, a regeneration process may be performed in the second tower 364. In an embodiment, the second tower 364 may maintain pressure similar to the first tower 362 for approximately 5 seconds to approximately 10 seconds and reduce pressure to the atmospheric pressure, and thereafter may perform the regeneration process.

The regeneration process may include a heating step and a cooling step. The regeneration process may further include a pressure increasing step. The regeneration process may further include a waiting step.

The regeneration process may be performed in a purge method and/or a non-purge method. For example, the regeneration process may be performed in the purge method in which dry air is used as regeneration gas, and/or the non-purge method in which outer air is used as regeneration gas. Hereinafter, an embodiment using the purge method using dry air will be described.

### (a) Heating Step

At the heating step, heated regeneration gas may be supplied to the second tower 364 to desorb water.

Referring to FIG. 5C, a portion of dry air dehumidified in the first tower 362 may be drawn into the regeneration line 330 and supplied to the second tower 364. The dry air may be drawn into the dry air inlet pipe 332 coupled to the outlet line 320 and may be maintained at an appropriate flow rate and an appropriate pressure by the flow control valve V32b, the orifice 332B, and the reducing valve V32c. The dry air drawn into the dry air inlet pipe 332 may be heated by the heater 340 installed on the regeneration confluent pipe 335 while passing through the regeneration confluent pipe 335. The dry air may be heated by, for example, the heater 340 to a temperature ranging from approximately 150° to approximately 220° C., and may be supplied to the second tower 364 through the second supply pipe 338B. Referring to FIG. 5C, the first regeneration valve V38A may be closed, and the second regeneration valve V38B may open.

The heated dry air may absorb water that has been adsorbed. The air that contains water removed from the adsorbent may pass through the second branch inlet pipe 314B and the second purging pipe 316B and may be discharged to the atmosphere. In an embodiment, air passing through the second purging pipe 316B may be discharged to the atmosphere via the silencer 318. Referring to FIG. 5C, the first purging valve V16A may be closed, and the second purging valve V16B may open.

The foregoing heating step may be performed, e.g., for a time ranging from approximately 2.0 hours to approximately 2.5 hours. The duration of the heating step may be set by a timer provided in the control unit 305.

### (b) Cooling Step

After the heating step is performed as described above, the adsorbent may be cooled to recover the function of the adsorbent, during the cooling step.

During the cooling step, dry air and/or outer air may be used. For example, in case that dry air is used, a heating operation of the heater 340 may be interrupted after the heating step is performed. For example, a portion of dry air dehumidified in the first tower 362 may be drawn into the regeneration line 330 and supplied to the second tower 364. The dry air may be drawn into the dry air inlet pipe 332 coupled to the outlet line 320 and may be maintained at an appropriate flow rate and an appropriate pressure by the flow control valve V32b, the orifice 332B, and the reducing valve V32c. The dry air that is drawn into the dry air inlet pipe 332 may pass through the regeneration confluent pipe 335 without being heated by the heater 340 and may be supplied to the second tower 364 through the second supply pipe 338B.

The dry air that is supplied to the second tower 364 may cool the adsorbent with which the second tower 364 is filled, and may pass through the second branch inlet pipe 314B and the second purging pipe 316B and be discharged to the atmosphere via the silencer 318 in the same manner as the heating step.

The foregoing cooling step may be performed, e.g., for a time ranging from approximately 1.5 hours to approximately 2.0 hours. The duration of the cooling step may be set by a timer provided in the control unit 305.

### (c) Pressure Increasing Step

After the foregoing cooling step is performed, the pressure in the second tower 364 may be equal to or similar to the atmospheric pressure. During the heating step and the cooling step, the driving pressure of the first tower 362 and the pressure in the second tower 364 may be largely different. In case that the tower performing the adsorbent process and the tower performing the regeneration process are immediately switched to each other (for example, the tower switching process is immediately performed), damage to the adsorbent or a pressure hunting phenomenon may be caused.

To prevent the foregoing problems, a step of increasing the pressure in the second tower 364 to the driving pressure by closing the second purging valve V16B and drawing dry air into the second tower 364 may be provided. The pressure increasing step may be performed, e.g., for a time ranging from approximately 2.0 minutes to approximately 5.0 minutes. The duration of the pressure increasing step may be set by the timer provided in the control unit 305.

In accordance with embodiments of the disclosure, the foregoing regeneration process (e.g., the heating step and the cooling step) may be performed using the non-purge method using outer air as regeneration gas so as to reduce energy consumption. In case that outer air is used as the regeneration gas, the regeneration process may be performed in the same manner as the foregoing.

For example, after outer air is drawn from the outside through the outer air supply unit 350, the outer air may be supplied to the second tower 364 through the outer air inlet pipe 334 and the second supply pipe 338B so that the regeneration process (including the heating step and the cooling step) can be performed.

In case that outer air is used, because the outer air of the atmosphere generally has higher humidity and lower temperature, the outer air itself may not be suitable for the regeneration gas. Therefore, at the heating step, outer air may be heated by the heater 340 installed on the regeneration confluent pipe 335, and supplied to the second tower 364 to desorb water. In the cooling step, the adsorbent with which the second tower 364 is filled may also contain moisture due to the humidity of the outer air. In the cooling step, outer air may be condensed by a condenser (not shown) so that water can be removed from the outer air, and thereafter, the outer air from which water has been removed may be supplied to the second tower 364.

In an embodiment, during the regeneration process (e.g., the heating step and the cooling step), outer air drawn from the outer air inlet pipe 334 may be used as the regeneration gas that is used at the heating step, and dry air drawn into the dry air inlet pipe 332 may be used as the regeneration gas that is used at the cooling step. In an embodiment, during the regeneration process (e.g., the heating step and the cooling step), dry air drawn into the dry air inlet pipe 332 may be used as the regeneration gas that is used at the heating step, and outer air drawn from the outer air inlet pipe 334 may be used as the regeneration gas that is used at the cooling step.

(d) Waiting Step

After the pressure increasing step, a waiting step may be performed. The states of the valves V14A, V14B, V16A, V16B, V24A, V24B, V32b, V32c, V34, V38A, V38B, and the like at the waiting step may be almost the same as the states at the pressure increasing step. However, there is a difference in that regeneration gas is not supplied to the second tower 364. In other words, although the pressure in the second tower 364 is maintained at almost the same pressure as the driving pressure of the first tower 362 after the pressure increasing step, the adsorption process may not be performed. Furthermore, the heating step, the cooling step, and the pressure increasing step of the regeneration process may not be performed, and the step may be defined as the waiting step.

The waiting step may be advantageous for reducing energy. For example, although the adsorption process is performed in the first tower 362 to produce dry air, the heating step, the cooling step, or the like is not performed in the second tower 364, so that there may be almost no energy consumption (e.g., consumption of electricity, or inflow or outflow of inner air of the second tower 364) in the second tower 364. As a period of the waiting step increases, the amount of energy consumption of the drying device 220 per hour may be reduced (e.g., the energy efficiency is increased).

The waiting step may continue from termination of the pressure increasing step until the tower switching process is performed. Because in the regeneration process, the length of time it takes to perform the heating step, the cooling step, and the pressure increasing step may be substantially constant, the duration of the waiting step in the second tower 364 may be increased by increasing duration of the adsorption process in the first tower 362.

In accordance with embodiments of the disclosure, the duration of the waiting step of the first tower 362 and the second tower 364 may be controlled based on at least one of the temperature, the relative humidity, and the pressure of outer air drawn into the intake port INN.

### [3] Tower Switching Process

The tower switching process may be performed. For example, in case that the tower switching process is performed, a regeneration process may be performed in the first tower 362 that has performed the adsorption process, and an adsorption process may be performed in the second tower 364 that has performed the regeneration process.

The adsorption process and the regeneration process that are performed after the tower switching process are the same as that described above.

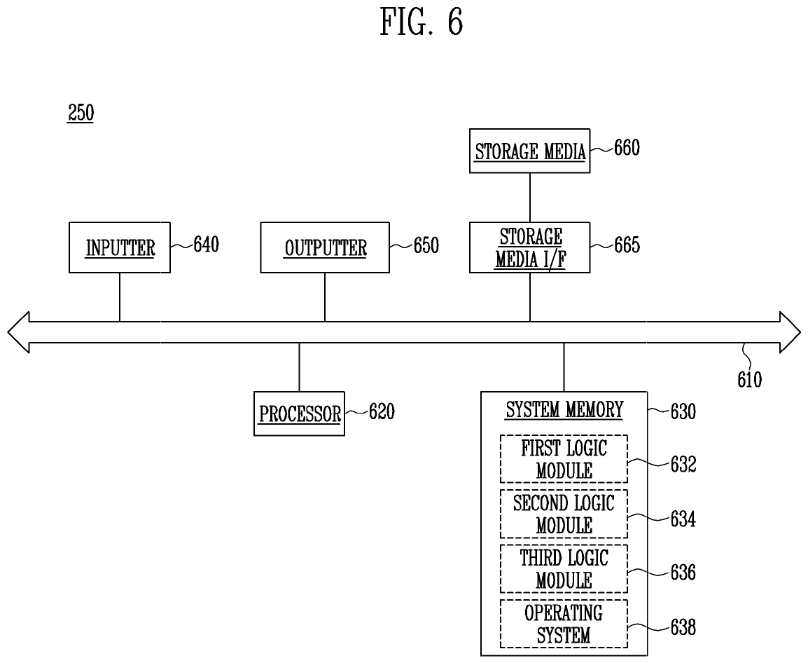

FIG. 6 is a schematic system block diagram of the controlling device 250 in accordance with embodiments of the disclosure.

Referring to FIG. 6, the controlling device 250 in accordance with embodiments of the disclosure may include a bus 610, a processor 620, a system memory 630, an inputter 640, an outputter 650, storage media 660, a storage media interface 665, and the like

The controlling device 250 in accordance with embodiments of the disclosure may be implemented as an electronic device including a computer or the like. The controlling device 250 in accordance with embodiments of the disclosure may be implemented as a system on chip (SoC) in which multiple functional blocks are mounted on a single chip. The controlling device 250 in accordance with embodiments of the disclosure is not limited to the above-described embodiments. Hereinafter, for convenience of explanation, an embodiment of the controlling device 250 implemented as one computer will be described.

The bus 610 may be coupled to various components of the controlling device 250 to transmit data, signals, information, or the like to the components.

The processor 620 may be one of a universal processor or a dedicated processor. The processor 620 may control overall operations of the controlling device 250. The processor 620 may be configured to load, to a system memory 630, program codes and commands for providing various functions and process the loaded program codes and the commands.

The system memory 630 may be provided as a working memory and/or a buffer memory of the processor 620. In an embodiment, the system memory 630 may include at least one of a random access memory (RAM), a read only memory (ROM), and media which are readable by another type of computer.

An operating system 638 may be stored in the system memory 630.

The processor 620 may load, to the system memory 630, a first logic module 632 which calculates, a time (e.g., the maximum time) for which an adsorption process can be continuously performed in the drying device 220 (refer to FIG. 2) based on an outer air conditioning signal OAC (refer to FIG. 2).

The processor 620 may load, to the system memory 630, a second logic module 634 which determines whether the drying device 220 (refer to FIG. 2) has malfunctioned based on an inner air conditioning signal IAC (refer to FIG. 2).

The processor 620 may load, to the system memory 630, a third logic module 636 which controls the opening rate of the valve 230 (refer to FIG. 2) based on an inner air conditioning signal IAC (refer to FIG. 2).

The program codes and/or commands of the first logic module 632 may be stored in the storage media 660. The program codes and/or commands of the first logic module 632 may be executed by the processor 620.

The first logic module 632 may calculate a length of time for which an adsorption process can be continuously performed in the drying device 220 (refer to FIG. 2), based on an outer air conditioning signal OAC (refer to FIG. 2) inputted through the inputter 640.

The first logic module 632 may calculate the length of time for which the adsorption process can be continuously performed, based on at least one of the temperature of, the relative humidity, and the pressure of outer air included in the outer air conditioning signal OAC (refer to FIG. 2). For example, the first logic module 632 may calculate the absolute humidity of the outer air, using an equation.

The first logic module 632 may calculate the length of time for which the adsorption process can be continuously performed based on the calculated absolute humidity of the outer air.

The first logic module 632 may count whether time has passed the calculated length of time. The controlling device 250 may determine the time using, for example, an internal clock signal generator (not illustrated) and a flip-flop (not illustrated), but the disclosure is not limited thereto.

The first logic module 632 may determine whether time has passed the calculated length of time. In case that it is determined that time has passed the calculated length of time, the first logic module 632 may output the above-described drying device control signal DCS (refer to FIG. 2) through the outputter 650. The drying device control signal DCS may include a signal to instruct the tower switching process to be performed.

The foregoing functions of the first logic module 632 may be implemented in one module, as illustrated in FIG. 6, or may be implemented in two or more separate modules.

The program codes and/or commands of the second logic module 634 may be stored in the storage media 660. The program codes and/or commands of the second logic module 634 may be executed by the processor 620.

The second logic module 634 may determine whether the drying device 220 (refer to FIG. 2) has malfunctioned, based on an inner air conditioning signal IAC (refer to FIG. 2) inputted through the inputter 640.

The second logic module 634 may determine whether the drying device 220 (refer to FIG. 2) has malfunctioned, based on at least one of the temperature, the relative humidity, and the pressure of inner air that are included in the inner air conditioning signal IAC. For example, the second logic module 634 may calculate the absolute humidity of the inner air, using an equation.

The second logic module 634 may determine whether the drying device 220 (refer to FIG. 2) has malfunctioned, based on the calculated absolute humidity of the inner air.

The program codes and/or commands of the third logic module 636 may be stored in the storage media 660. The program codes and/or commands of the third logic module 636 may be executed by the processor 620.

The third logic module 636 may control the opening rate of the valve 230 (refer to FIG. 2), based on an inner air conditioning signal IAC (refer to FIG. 2) inputted through the inputter 640.

The third logic module 636 may control the opening rate of the valve 230, based on the flow data of air that is included in the inner air conditioning signal IAC. For example, to increase the flow rate of air discharged from the drying device 220 (refer to FIG. 2) that has a relatively low discharge air flow rate, the third logic module 636 may control the opening rate of the corresponding valve 230 (refer to FIG. 2) to be increased. For example, to reduce the flow rate of air discharged from the drying device 220 (refer to FIG. 2) that has a relatively high discharge air flow rate, the third logic module 636 may control the opening rate of the corresponding valve 230 (refer to FIG. 2) to be reduced. Consequently, the flow rates of air discharged from the drying devices 220a and 220b may be controlled.

The program codes and/or the commands may be loaded to the system memory 630 from the storage media 660, which are recording media readable by the controlling device 250. In another embodiment, the program codes and/or the commands may be loaded from an external device to the system memory 630 through a communicator (not illustrated).

The processor 620 may execute the operating system 638. For example, the processor 620 may load, to the system memory 630, the operating system 638 for providing environment suitable for executing at least one of the first logic module 632, the second logic module 634, and the third logic module 636, and may execute the operating system 638.

The operating system 638 may provide an interface between the first logic module 632 and the components of the controlling device 250 such as the inputter 640, the outputter 650, and the storage media interface 665 so that the first logic module 632 can use the components of the controlling device 250. The operating system 638 may also provide an interface between the second logic module 634 and the components of the controlling device 250 such as the inputter 640, the outputter 650, and the storage media interface 665 so that the second logic module 634 can use the components of the controlling device 250. The operating system 638 may also provide an interface between the third logic module 636 and the components of the controlling device 250 such as the inputter 640, the outputter 650, and the storage media interface 665 so that the third logic module 636 can use the components of the controlling device 250.

In embodiments of the disclosure, at least some functions of the inputter 640, the outputter 650, and the storage media interface 665 may be performed by the operating system 638.

Although the system memory 630 is illustrated as being a component separate from the processor 620, at least a portion of the system memory 630 may be included in the processor 620. The system memory 630 may be provided as multiple memories, which are physically and/or logically separated from each other depending on the embodiment.

The inputter 640 may be configured to receive an input such as a signal from an external device. For example, the controlling device 250 may receive the outer air conditioning signal OAC and/or the inner air conditioning signal IAC through the inputter 640. The outer air conditioning signal OAC and/or the inner air conditioning signal IAC that are inputted through the inputter 640 may be stored in the storage media 660 or loaded to the system memory 630. The inputter 640 may include a communicator (for example, a modem) which can communicate with other terminals and/or servers through a network. The network may include a wired network and a wireless network.

The controlling device 250 may further include an inputter interface (not illustrated). The inputter interface may interface the inputter 640 with components such as the processor 620 and the system memory 630, which are connected to the bus 610.

The outputter 650 may be configured to output a signal or the like to an external device. For example, the controlling device 250 may output the drying device control signal DCS (refer to FIG. 2) and/or the valve control signal VCS through the outputter 650. The outputter 650 may be configured as a component separate from the inputter 640, or the outputter 650 and the inputter 640 may be implemented in one component (e.g., a communicator or the like), in some embodiments.

The controlling device 250 may further include an outputter interface (not illustrated). The outputter interface may interface the outputter 650 with components such as the processor 620 and the system memory 630, which are connected to the bus 610.

The storage media 660 may be configured to store data. The storage media 660 may include various types of nonvolatile storage media capable of maintaining stored data even in case that power is interrupted. The nonvolatile storage media may include, for example, a flash memory and a hard disk.

The storage media interface 665 may be connected to the storage media 660. The storage media interface 665 may interface the storage media 660 with components such as the processor 620 and the system memory 630, which are connected to the bus 610.

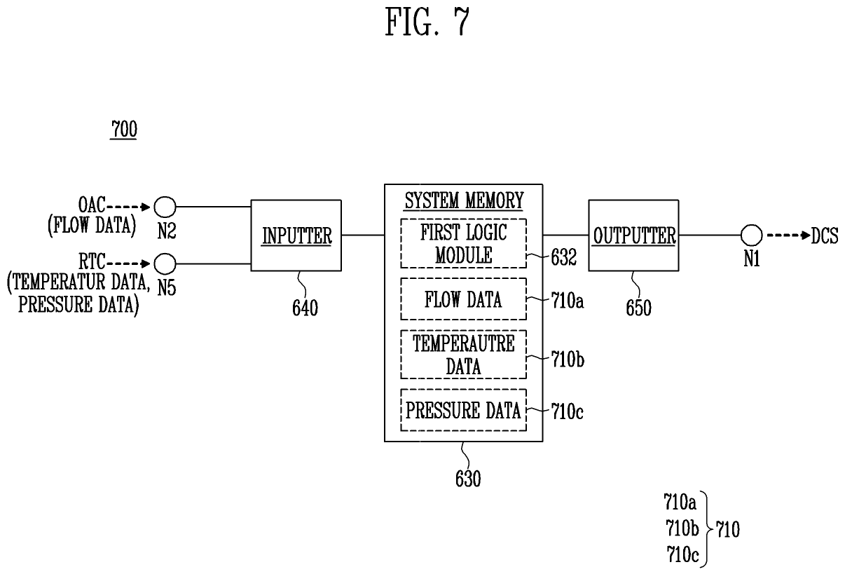

FIG. 7 is a schematic block diagram for describing step 700 of setting the drying device control signal DCS, based on the flow data FLOW DATA of air, the temperature data TEMPERATURE DATA of air, and the pressure data PRESSURE DATA of air, in a method of controlling the air drying system in accordance with embodiments of the disclosure.

Referring to FIG. 7, the inputter 640 may include a second node N2 and a fifth node N5. The outer air conditioning signal OAC may be inputted to the second node N2. The receiver tank conditioning signal RTC may be inputted to the fifth node N5.

The second node N2 and the fifth node N5 each may include one or more pins (e.g., pads).

FIG. 7 illustrates that the outer air conditioning signal OAC includes the flow data FLOW DATA of air, and the receiver tank conditioning signal RTC includes the temperature data TEMPERATURE DATA and the pressure data PRESSURE DATA of air. However, the disclosure is not limited thereto, and as described with reference to FIGS. 3 and 4, the outer air conditioning signal OAC may further include the temperature data TEMPERATURE DATA of air and/or the pressure data PRESSURE DATA of air. In an embodiment, the receiver tank conditioning signal RTC may be omitted.

Flow data 710a of air, temperature data 710b of air, and pressure data 710c of air may be loaded to the buffer memory 710 of the system memory 630. The step of loading the flow data 710a of air, the temperature data 710b of air, and the pressure data 710c of air to the system memory 630 may be performed by the processor 620 (refer to FIG. 6).

The absolute humidity of the outer air increases as the temperature of the outer air rises, as the relative humidity of the outer air rises, and as the pressure of the outer air decreases.

The higher the absolute humidity of the outer air, the larger the amount of water that is absorbed by the adsorbent during the adsorption process. Therefore, as the absolute humidity of the outer air increases, the length of time for which the adsorption process can be continuously performed may be reduced.

The first logic module 632 may calculate the length of time for which the adsorption process can be continuously performed, based on at least one of the temperature of the outer air, the absolute humidity of the outer air, and the pressure of the outer air.

For example, the first logic module 632 may calculate the absolute humidity of outer air by the following equation 1.

$${x}_{2} = 0.622 \frac{ϕ {P}_{S}}{P - ϕ {P}_{S}} \qquad [ Equation 1 ]$$

In equation 1, x₂ on the left side may be an absolute humidity (kg/kg) of outer air. The absolute humidity may be a value obtained by dividing the mass of water contained in the outer air by the weight of the outer air. 0.622 on the right side may be a constant, and may be a value obtained from the ideal gas equation. P may be a pressure hPa of the outer air. φ may be a relative humidity (kg/kg) of the outer air. Ps may be a saturated vapor pressure (hPa) according to the temperature of the outer air.

An absolute humidity value of the outer air may be calculated by equation 1.

In an embodiment, the first logic module 632 may be a look-up table of a psychrometric chart.

The first logic module 632 may calculate the amount of water removed from the outer air per hour, by the following equation 2.

W=γ [symbol] (x₂−x₁) [Equation 2]

In equation 2, W on the left side may be the amount of water removed per hour (kg/hr). γ on the right side may be a density (kg/m3) of outer air. Q may be a flow rate (m3/hr) of the outer air. x₂ may be an absolute humidity of the outer air. x₁ may be an absolute humidity of inner air.

The absolute humidity of the inner air may be a preset value depending on environment in case that the air drying system 100 (refer to FIG. 1) in accordance with embodiments of the disclosure is used. In equation 2, the absolute humidity x₁ of the inner air may be a reference value. The absolute humidity of air discharged from the air drying system 100 (refer to FIG. 1) may have a value identical or similar to the absolute humidity x₁ of the inner air.

The amount of water removed from the outer air per hour may be calculated by equation 2.

Referring to equation 2, the amount (W) of water removed from the outer air per hour may increase as the absolute humidity (x₂) of the outer air rises.

Referring to equation 2, in case that the absolute humidity of the outer air is low, the amount of water adsorbed to the adsorbent during the adsorption process may be relatively small, and the adsorption process may be continuously performed for a comparatively longer time. In contrast, in case that the absolute humidity of the outer air is high, the amount of water adsorbed to the adsorbent during the adsorption process may be relatively large, and the adsorption process may be continuously performed for a comparatively shorter time.

Referring to equation 2, in embodiments of the disclosure, the amount of water removed from the outer air per hour may be calculated, considering the flow rate (Q) of the outer air and the absolute humidity (x₂) of the outer air. Consequently, the length of time for which the adsorption process can be continuously performed may be more precisely calculated.

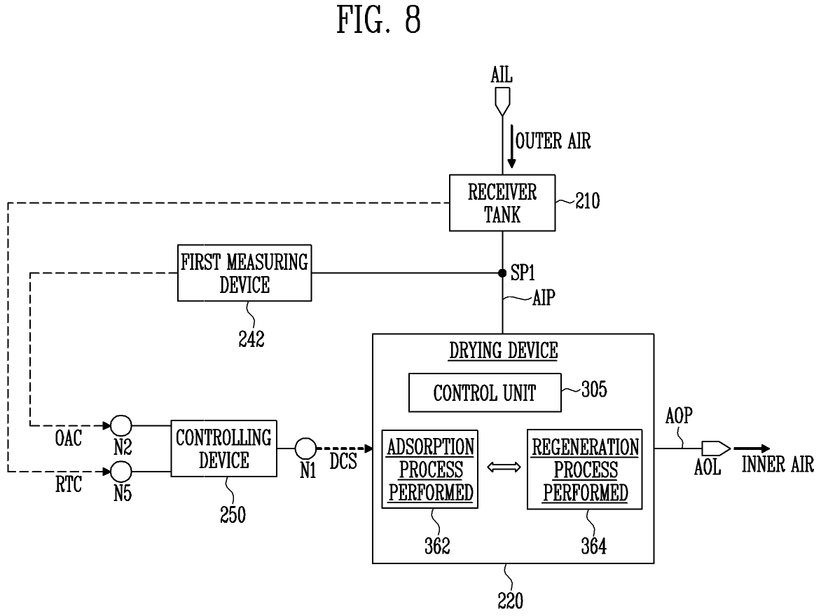

FIG. 8 is a schematic diagram illustrating an operation of controlling the drying device 220 in response to the drying device control signal DCS of FIG. 7.

Referring to FIG. 8, outer air OUTER AIR may be drawn through the outer air inlet AIL, and the drawn outer air OUTER AIR may be stored in the receiver tank 210. The stored air may be discharged from the receiver tank 210, and the discharged air may be transmitted to the drying device 220 through the intake pipe AIP.

The first measuring device 242 may generate an outer air conditioning signal OAC including flow data of air or the like measured at the first sampling point SP1, and output the generated outer air conditioning signal OAC to the controlling device 250.

The receiver tank 210 may generate a receiver tank conditioning signal RTC including temperature data of the stored air, pressure data of the stored air, and the like, and output the generated receiver tank conditioning signal RTC.

The controlling device 250 may calculate a length of time for which the adsorption process can be continuously performed in the drying device 220, based on the inputted outer air conditioning signal OAC and/or the receiver tank conditioning signal RTC. For example, the controlling device 250 may calculate an absolute humidity of the outer air based on the inputted outer air conditioning signal OAC, and calculate the length of time for which the adsorption process can be continuously performed in the drying device 220, based on the calculated absolute humidity.

In the drying device 220, under control of the control unit 305, an adsorption process may be performed in one of the first tower 362 and the second tower 364, and a regeneration process may be performed in another one of the first tower 362 and the second tower 364.

The controlling device 250 may output, based on the calculated length of time, a drying device control signal DCS for instructing the tower in which the adsorption process is performed to be switched (e.g., for instructing a tower to perform a switching process) at an appropriate timing.

Furthermore, in case that the air drying system 100 (refer to FIG. 1) includes multiple drying devices 200, the controlling device 250 may output the drying device control signal DCS such that tower switching process are sequentially performed for the drying devices 200. A phenomenon in which inner air INNER AIR is not discharged (or slightly discharged) in case that the drying devices 200 simultaneously enter the tower switching processes may be prevented from occurring.

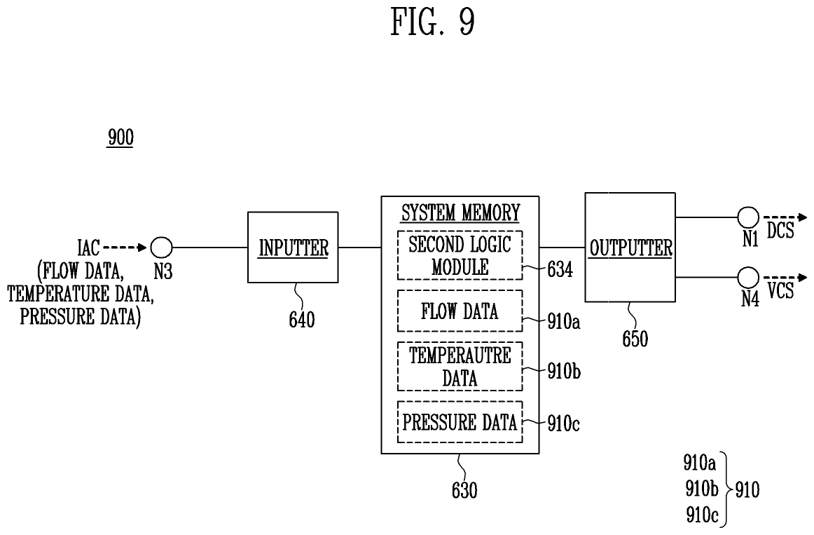

FIG. 9 is a schematic block diagram illustrating step 900 of setting one or more of the drying device control signal DCS and the valve control signal VCS based on the inner air conditioning signal IAC, in the method of controlling the air drying system in accordance with embodiments of the disclosure.

Referring to FIG. 9, the inputter 640 may include a third node N3. An inner air conditioning signal IAC may be inputted to the third node N3. The third node N3 may include one or more pins (e.g., pads).

The outputter 650 may include the first node N1 from which the drying device control signal DCS is outputted, and a fourth node N4 from which the valve control signal VCS is outputted. The first node N1 and the fourth node N4 each may include one or more pins (e.g., pads).

The inner air conditioning signal IAC may include at least one of the temperature of the inner air, the relative humidity of the inner air, and the pressure of the inner air. Flow data 910a of air, temperature data 910b of air, pressure data 910c of air, and the like may be loaded to the buffer memory 910.

In an embodiment, the second logic module 634 may compare data of the inner air conditioning signal IAC stored in the buffer memory 910 with a pre-stored parameter value, and determine whether at least one of the temperature of the inner air, the relative humidity of the inner air, and the pressure of the inner air is out of a normal range.

In an embodiment, the second logic module 634 may compare data of the inner air conditioning signal IAC stored in the buffer memory 910 with a pre-stored parameter value, and determine whether the absolute humidity of the inner air is out of a normal range (e.g., whether the absolute humidity of the inner air is greater than the pre-stored parameter value).

For example, the second logic module 634 may calculate the absolute humidity of the inner air according to equation 3 similar to equation 1 described above.

$${x}_{1}^{′} = 0.622 \frac{ϕ {P}_{S}}{P - ϕ {P}_{S}} \qquad [ Equation 3 ]$$

In equation 3, x₁′ on the left side may be a calculated absolute humidity (kg/kg) of inner air, and may be a value obtained by dividing the mass of water contained in the inner air by the weight of the inner air. 0.622 on the right side may be a constant, and may be a value obtained from the ideal gas equation. P may be a pressure hPa of the inner air. φ may be a relative humidity (kg/kg) of the inner air. Ps may be a saturated vapor pressure (hPa) according to the temperature of the inner air.

An absolute humidity value x₁′ of the inner air may be calculated by equation 3.

The second logic module 634 may compare the absolute humidity value x₁′ of the inner air that is calculated by equation 3 with the pre-stored parameter value, and determine whether the absolute humidity of the inner air is within the normal range.

In an embodiment, the parameter value that is used in the second logic module 634 may be the absolute humidity x₁ of the inner air that is described in equation 2.

In an embodiment, the parameter value that is used in the second logic module 634 may be a value (e.g., x₁+ε) obtained by adding a certain error value ε(where, ε>0) to the absolute humidity x₁ of the inner air that is described in equation 2.

In case that the calculated absolute humidity value x₁′ of the inner air is equal to or less than the preset parameter value (e.g., x₁, or x₁+ε), the second logic module 634 may determine that the drying device 220 (refer to FIG. 2) is normally operated. In case that it is determined that the drying device 220 (refer to FIG. 2) is normally operated, the outputter 650 may output a drying device control signal DCS and/or a valve control signal VCS so that an adsorption process and/or a regeneration process can be performed in the corresponding drying device.

In case that the calculated absolute humidity value x₁′ of the inner air exceeds the preset parameter value (e.g., x₁ or x₁+ε, the second logic module 634 may determine that the drying device 220 (refer to FIG. 2) has malfunctioned. In case that it is determined that the drying device 220 (refer to FIG. 2) has malfunctioned, the outputter 650 may output a drying device control signal DCS and/or a valve control signal VCS so that the adsorption process in the corresponding drying device is suspended.

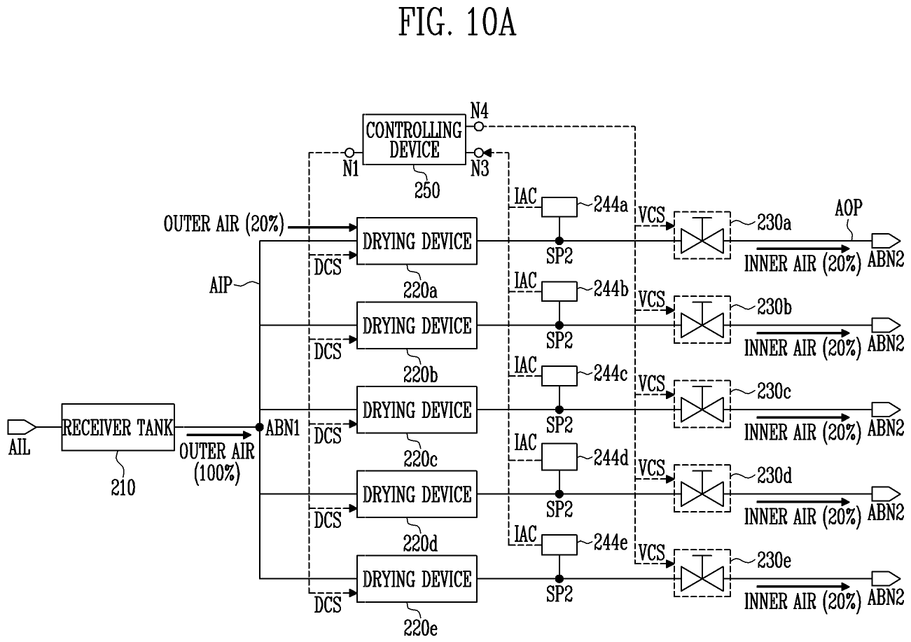

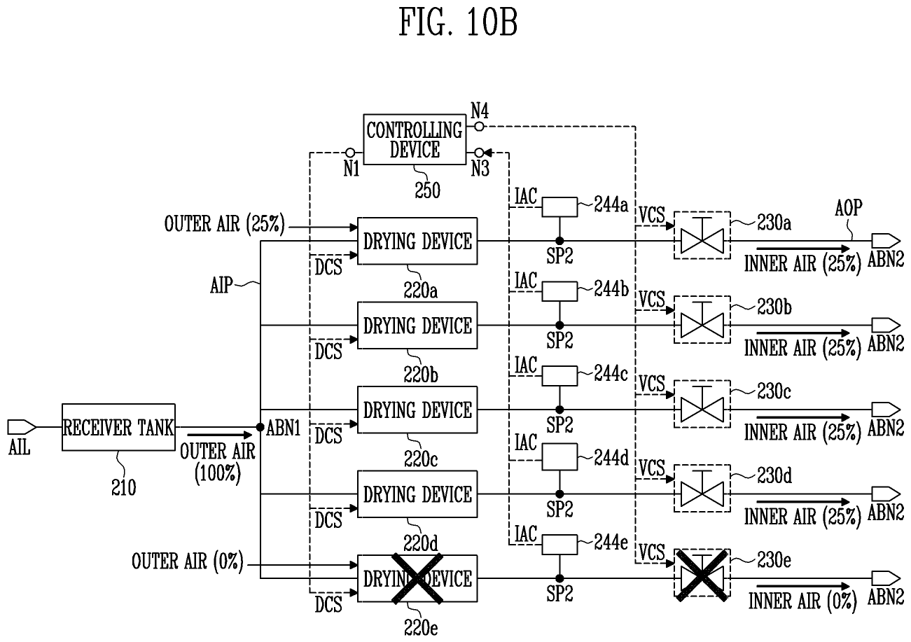

FIGS. 10A and 10B are schematic diagrams illustrating operations of controlling the air drying system 100 (refer to FIG. 1) using a drying device control signal DCS and a valve control signal VCS in accordance with an embodiment of the disclosure.

Referring to FIG. 10A, outer air may be discharged from the receiver tank 210, and the outer air may be drawn into the drying device 220 through an intake pipe AIP.

The intake pipe AIP may branch from the first branch node ABN1 into pipes coupled to the drying devices 220a, 220b, 220c, 220d, and 220e.

Multiple drying devices 220a, 220b, 220c, 220d, and 220e may be respectively coupled to exhaust pipes AOP. Valves (e.g., a first valve 230a, a second valve 230b, a third valve 230c, a fourth valve 230d, and a fifth valve 230e) may be disposed on (e.g., installed on or coupled to) respective exhaust pipes AOP that are coupled to the drying devices (e.g., a first drying device 220a, a second drying device 220b, a third drying device 220c, a fourth drying device 220d, and a fifth drying device 220e).

Referring to FIG. 10A, second measuring devices 244a, 244b, 244c, 244d, and 244e may be disposed (e.g., installed) on the respective exhaust pipes AOP. Each second measuring device 244a, 244b, 244c, 244d, 244e may measure the temperature, the relative humidity, the pressure, the flow rate, and the like of inner air drawn into the corresponding exhaust pipe AOP at a corresponding second sampling point SP2 (e.g., at the second sampling point SP2).

The controlling device 250 may receive an inner air conditioning signal IAC from each of the second measuring devices 244a, 244b, 244c, 244d, and 244e. The controlling device 250 may determine whether each of the drying devices 220a, 220b, 220c, 220d, and 220e has malfunctioned (e.g., whether an adsorption process is normally performed), based on the inner air conditioning signal IAC.

FIG. 10A illustrates an embodiment in which the drying devices 220a, 220b, 220c, 220d, and 220e are normally operated.

The controlling device 250 may output the drying device control signal DCS and the valve control signal VCS such that a substantially identical amount of inner air can be discharged from the drying devices 220a, 220b, 220c, 220d, and 220e.

A pipe diameter of the intake pipe AIP (e.g., a diameter or a radius of the intake pipe AIP) may be a factor affecting the flow rate. Referring to FIG. 10A, in embodiments of the disclosure, considering the pipe diameter of the intake pipe AIP that connects the drying devices 220a, 220b, 220c, 220d, and 220e and the receiver tank 210, the opening rates of the valves 230a, 230b, 230c, 230d, and 230e may be controlled.

For example, referring to FIG. 10A, it is assumed that the pipe diameter of the intake pipe AIP extending from the receiver tank 210 to the first branch node ABN1 is 1 (1 is a relative value). FIG. 10A illustrates an embodiment in which the intake pipe AIP branches into the first to fifth drying devices 220a to 220e at the first branch node ABN1. For example, the intake pipe AIP extending from the receiver tank 210 to the first branch node ABN1 may branch, at the first branch node ABN1, into five pipes each having a pipe diameter of about 0.45.

In an embodiment, the pipe diameter of the intake pipe AIP may successively decrease, unlike the embodiment illustrated in FIG. 10A. In an embodiment, the intake pipe AIP may include one or more first branch nodes ABN1. In an embodiment, the intake pipe AIP may successively branch. In an embodiment, the intake pipe AIP may successively branch to be coupled to the first to fifth drying devices 220a to 220e.

For example, it is assumed that a relative value of the pipe diameter of the intake pipe AIP that is directly coupled to the receiver tank 210 is 1. The intake pipe AIP may branch at one of multiple first branch nodes into an intake pipe AIP having a pipe diameter of about 0.45 and an intake pipe AIP having a pipe diameter of about 0.89. The intake pipe AIP having a pipe diameter of about 0.89 may branch at another one of the first branch nodes into an intake pipe AIP having a pipe diameter of about 0.45 and an intake pipe AIP having a pipe diameter of about 0.77.

In an embodiment, the intake pipe AIP having a pipe diameter of 1 may branch into an intake pipe AIP having a pipe diameter of about 0.2 and an intake pipe AIP having a pipe diameter of about 0.77.

As described above, the pipe diameter of the intake pipe AIP may be a factor affecting the flow rate. Even though the opening rates of the valves 230a, 230b, 230c, 230d, and 230e are the same, the flow rates of air exhausted from the drying devices 220a, 220b, 220c, 220d, and 220e may be different. The controlling device 250 may control the opening rates of the valves 230a, 230b, 230c, 230d, and 230e, considering the pipe diameter of the intake pipe AIP.

For example, in embodiments of the disclosure, to allow the drying devices 220a, 220b, 220c, 220d, and 220e to remove substantially the same amount of water per time, the opening rates of the valves 230a, 230b, 230c, 230d, and 230e may be controlled to be different from each other, considering the pipe diameters of the intake pipes AIP between the receiver tank 210 and the drying devices 220a, 220b, 220c, 220d, and 220e. According to the foregoing, because the amounts of water removed from the drying devices 220a, 220b, 220c, 220d, and 220e per time are substantially the same as each other, calculation of the length of time for which an adsorption process can be continuously performed in each of the drying devices 220a, 220b, 220c, 220d, and 220e may be further simplified.

In embodiments of the disclosure, the drying devices 220a, 220b, 220c, 220d, and 220e may dry and discharge air at substantially the same flow rate per time (e.g., each 20% of air drawn into the intake pipe AIP).

FIG. 10B illustrates an embodiment the fifth drying device 220e has malfunctioned.

The same description described with reference to FIG. 10A will be omitted.

The controlling device 250 may receive an inner air conditioning signal IAC from the second measuring device 244e that measures the flow rate of air flowing through the exhaust pipe AOP coupled to the fifth drying device 220e. The controlling device 250 may determine that the fifth drying device 220e has malfunctioned, based on the received inner air conditioning signal IAC.

In an embodiment, the controlling device 250 may output a drying device control signal DCS to instruct the fifth drying device 220e to suspend the adsorption process.

In an embodiment, the controlling device 250 may output a valve control signal VCS for closing the valve 230e installed on the exhaust pipe AOP coupled to the fifth drying device 220e.

In an embodiment, outer air may not be drawn into the drying device that has malfunctioned. The flow rate of outer air drawn into each of other drying devices that are normally operated may be increased (e.g., to about 25% of the outer air).

Because the flow rate of outer air drawn into each of the other drying devices that are normally operated is increased, at least one of the temperature, the relative humidity, the pressure, and the flow rate of air drawn into the intake pipe AIP may be changed.

The outer air conditioning signal OAC outputted from the first measuring device 242 (refer to FIG. 8) to the controlling device 250 (refer to FIG. 8) may be changed. The length of time for which the adsorption process can be continuously performed in the drying device 220 may be changed. In accordance with embodiments of the disclosure, the timing at which the tower switching process is performed may be controlled, based on the changed length of time.

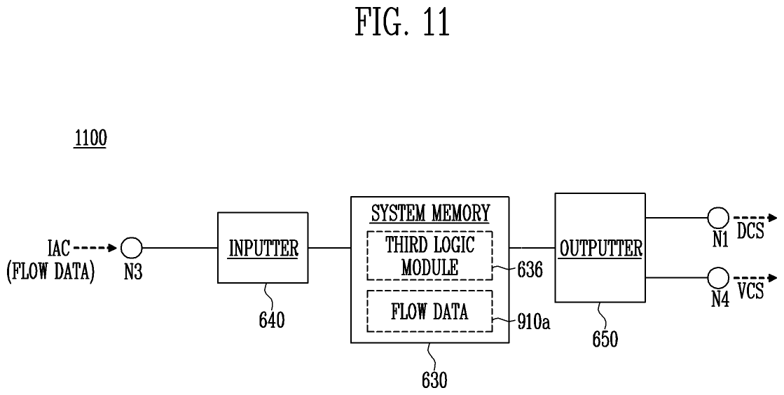

FIG. 11 is a schematic diagram illustrating step 1100 of controlling the air drying system based on the flow data FLOW DATA in accordance with embodiments of the disclosure.

Referring to FIG. 11, the inner air conditioning signal IAC may be inputted through the third node N3 to the inputter 640. The inner conditioning signal IAC may include the flow data FLOW DATA of air.

Data (e.g., the flow data FLOW DATA of air) included in the inner air conditioning signal IAC may be loaded to the buffer memory 910.

The third logic module 636 may determine whether the flow rates of air discharged from multiple drying devices (e.g., the first to fifth drying devices 220a to 220e (refer to FIG. 10A)) are uniform, based on the data of the inner air conditioning signal IAC stored in the buffer memory 910.

The controlling device 250 (refer to FIG. 2) may output, based on a result of the determination, a valve control signal VCS for controlling multiple valves (e.g., the first to fifth valves 230a to 230e) to make the flow rates of air discharged from the drying devices uniform.

The third logic module 636 may control the outputter 650 to output a valve control signal VCS, based on the result of the determination.

The controlling device 250 (refer to FIG. 2) may determine whether the drying device 220 (refer to FIG. 2) has malfunctioned, based on the flow data FLOW DATA of air, and output a drying device control signal DCS and/or a valve control signal VCS to prevent air from being discharged from a drying deice that is determined to have malfunctioned.

For example, refer to FIG. 10B described above, in case that the controlling device determines that a drying device (e.g., the fifth drying device 220e) among multiple drying devices (e.g., the first to fifth drying devices 220a to 220e) discharges air at an excessive high flow rate or an excessive low flow rate, the controlling device may output a drying device control signal DCS and/or a valve control signal VCS to prevent air from being discharged from the corresponding drying device (e.g., the fifth drying device 220e). The controlling device 250 may adaptively control the opening rates of multiple corresponding valves (e.g., the first to fourth valves 230a to 230d) so that air can be discharged from the other drying devices (e.g., the first to fourth drying devices 220a to 220d) at a uniform flow rate.

The third logic module 636 may control the outputter 650 to output a drying device control signal DCS and/or a valve control signal VCS, based on the result of the determination.

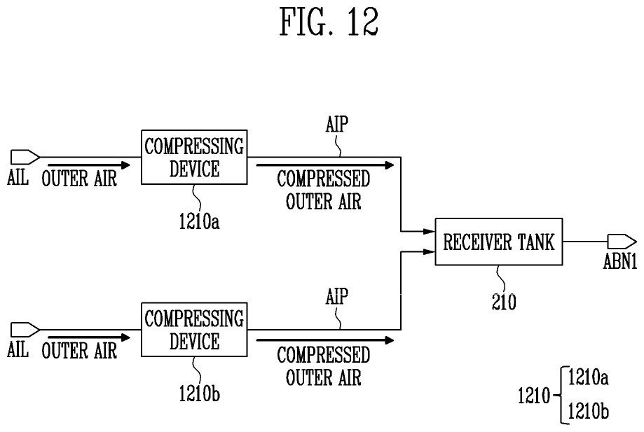

FIG. 12 is a schematic diagram illustrating the air drying system 100 (refer to FIG. 1) further including a compressing device 1210 in accordance with an embodiment of the disclosure.

The air drying system 100 in accordance with embodiments of the disclosure may further include the compressing device 1210 configured to supply compressed air. In an embodiment, the compressing device 1210 may be disposed between the outer air inlet AIL and the receiver tank 210.

The compressing device 1210 may draw air thereinto from the outside, compress the drawn air, and store the compressed air at high pressure.

Referring to FIG. 12, the compressing device 1210 may be coupled to the outer air inlet AIL. The compressing device 1210 may draw outer air (e.g., the atmospheric air) thereinto through the outer air inlet AIL and store the drawn air at high pressure, and discharge compressed outer air at a pressure higher than the atmospheric air.

The outer air discharged from the compressing device 1210 may be stored in the receiver tank 210. In an embodiment, the compressing device 1210 and the receiver tank 210 may be integrated into a single component.

In an embodiment, the receiver tank 210 may be supplied with compressed outer air from two or more compressing devices 1210a and 1210b. The compressed air may be stored in the receiver tank 210. The air stored in the receiver tank 210 may be discharged to the first branch node ABN1.

In embodiments of the disclosure, a uniform capacity of air may be discharged from each of multiple drying devices included in an air drying system. In embodiments of the disclosure, except a drying device determined to have malfunctioned, all of other drying devices may discharge air at a uniform flow rate (e.g., including the same flow rate, substantially the same flow rate, or the same level within a margin of error).

In embodiments of the disclosure, because air can be discharged from multiple drying devices included in the air drying system, it may be effective for reducing the flow velocity of air discharged from each of the drying devices. As the flow velocity of air passing through the drying device is reduced, the dehumidification efficiency of the drying device (e.g., by an adsorbent) may be enhanced (for example, the amount of water removed by the same amount of adsorbent per hour may be increased).

According to the foregoing, in embodiments of the disclosure, the dehumidification efficiency may be enhanced compared to the case where at least one drying device among the drying devices included in the air drying system is idle.

In an air drying system and a method of controlling the air drying system in accordance with embodiments of the disclosure, drying devices included in the air drying system may be controlled such that air can be discharged from the drying devices at a uniform flow rate, so that a flow velocity of air discharged from each drying device can be reduced, and dehumidification efficiency of each drying device can be enhanced.

In an air drying system and a method of controlling the air drying system in accordance with embodiments of the disclosure, the time for which an adsorption process is performed in the drying device can be controlled, considering conditions of the outer air.

In an air drying system and a method of controlling the air drying system in accordance with embodiments of the disclosure, the drying device can be controlled such that sufficient dry air can be discharged from the drying device, considering conditions of air discharged from the drying device.

The above description is an example of technical features of the disclosure, and those skilled in the art to which the disclosure pertains will be able to make various modifications and variations. Thus, the embodiments of the disclosure described above may be implemented separately or in combination with each other.

Therefore, the embodiments disclosed in the disclosure are not intended to limit the technical spirit of the disclosure, but to describe the technical spirit of the disclosure, and the scope of the technical spirit of the disclosure is not limited by these embodiments. The protection scope of the disclosure should be interpreted by the following claims, and it should be interpreted that all technical spirits within the equivalent scope are included in the scope of the disclosure.

What is claimed is:

1. An air drying system comprising:
a plurality of drying devices, each including an intake port that draws air into the plurality of drying devices, and an exhaust port that discharges air from the plurality of drying devices;
a plurality of measuring devices, each installed on an exhaust pipe coupled to the exhaust port of each of the plurality of drying devices, the plurality of measuring devices measuring flow rates of air discharged from the plurality of drying devices;
a plurality of valves, each installed on the exhaust pipe, the plurality of valves controlling the flow rates of air discharged from the plurality of drying devices; and
a controlling device that receives data from the plurality of measuring devices and controls the plurality of valves such that the flow rates of air discharged from the plurality of drying devices are uniform.

2. The air drying system according to claim 1, wherein in case that a flow rate of air discharged from one of the plurality of drying devices is less than the flow rates of air discharged from another ones of the plurality of drying devices, the controlling device controls the plurality of valves to increase the flow rate of air discharged from the one of the plurality of drying devices.

3. The air drying system according to claim 1, wherein in case that a flow rate of air discharged from one of the plurality of drying devices is greater than the flow rates of air discharged from another ones of the plurality of drying devices, the controlling device controls the plurality of valves to reduce the flow rate of air discharged from the one of the plurality of drying devices.

4. The air drying system according to claim 1, wherein the controlling device determines whether each of the plurality of drying devices has malfunctioned, based on the measured flow rates of air discharged from the plurality of drying devices.

5. The air drying system according to claim 1, wherein in case that one of the plurality of drying devices is determined to have malfunctioned, the controlling device closes one of the plurality of valves that controls a flow rate of air discharged from the one of the plurality of valves.

6. The air drying system according to claim 5, wherein the controlling device increases opening degrees of another ones of the plurality of valves.

7. An air drying system comprising:
an outer air inlet;
a receiver tank that stores air drawn from the outer air inlet;
a drying device comprising an intake port coupled to the receiver tank through an intake pipe, an exhaust port, a first tower, and a second tower;
a first measuring device that measures at least one of a temperature of air drawn into the intake pipe, a relative humidity of air drawn into the intake pipe, and a pressure of air drawn into the intake pipe, and outputs an outer air conditioning signal including a measured value; and
a controlling device that receives the outer air conditioning signal, wherein
an adsorbent is disposed in each of the first tower and the second tower,
one of the first tower and the second tower performs an adsorption process of dehumidifying air drawn from the intake port and discharging dried air,
another one of the first tower and the second tower performs a regeneration process of desorbing water from the adsorbent,
the exhaust port discharges the dried air, and
the controlling device calculates a length of time for which the adsorption process is allowed to be continuously performed in the one of the first tower and the second tower.

8. The air drying system according to claim 7, wherein
the first measuring device comprises a flow meter, and
the outer air conditioning signal further includes a flow rate of air flowing through the intake pipe.

9. The air drying system according to claim 7, wherein the controlling device comprises:
a processor; and
a system memory including a logic module executable by the processor,
wherein the logic module calculates the length of time for which the adsorption process is allowed to be continuously performed in the one of the first tower and the second tower.

10. The air drying system according to claim 9, wherein
the outer air conditioning signal further includes the temperature of air drawn into the intake pipe, the relative humidity of air drawn into the intake pipe, and the pressure of air drawn into the intake pipe,
the processor calculates the length of time for which the adsorption process is allowed to be continuously performed, based on an absolute humidity of air drawn into the intake pipe calculated by a following Equation,
$${x}_{2} = 0.622 \frac{ϕ {P}_{S}}{P - ϕ {P}_{S}} , \qquad Equation$$
and
in the Equation, x₂ is the absolute humidity of air drawn into the intake pipe, P is the pressure (hPa) of air drawn into the intake pipe, φ is the relative humidity of air drawn into the intake pipe, and Ps is a saturated vapor pressure based on the temperature of air drawn into the intake pipe.

11. The air drying system according to claim 7, wherein
the controlling device includes a first node that is electrically connected to the drying device and outputs a drying device control signal, and
in case that the length of time for which the adsorption process is allowed to be continuously performed has passed, the controlling device outputs, to the first node, the drying device control signal to instruct to perform a tower switching process such that the regeneration process is performed in the one of the first tower and the second tower, and the adsorption process is performed in the another one of the first tower and the second tower.

12. The air drying system according to claim 11, wherein
the drying device further comprises at least two drying devices, and
the controlling device controls the tower switching process to be performed among the at least two drying devices.

13. The air drying system according to claim 11, wherein the drying device further comprises a controller that controls a flow of air in the drying device in response to the drying device control signal.

14. The air drying system according to claim 7, further comprising:
a valve installed on an exhaust pipe coupled to the exhaust port;
an inner air outlet that discharges air drawn into the exhaust pipe; and
a second measuring device that measures at least one of a temperature of air drawn into the exhaust pipe, a relative humidity of air drawn into the exhaust pipe, and a pressure of air drawn into the exhaust pipe, and outputs an inner air conditioning signal including a measured value,
wherein the controlling device receives the inner air conditioning signal, determines whether the drying device has malfunctioned, and controls the adsorption process to be suspended in the drying device that is determined to have malfunctioned.

15. The air drying system according to claim 14, wherein the controlling device comprises:
a processor; and
a system memory including a logic module executable by the processor,
wherein the logic module compares the measured value included in the inner air conditioning signal with a preset value and determines whether the drying device has malfunctioned based on the comparison.

16. The air drying system according to claim 14, wherein
the drying device further comprises at least two drying devices, and
the controlling device controls, based on a pipe diameter of the intake pipe coupling each of the at least two drying devices to the receiver tank, opening degrees of the valve installed on the exhaust pipe of each of the at least two drying devices.

17. The air drying system according to claim 7, wherein the length of time for which the adsorption process is allowed to be continuously performed depends on at least one of the temperature of air drawn into the intake pipe, the relative humidity of air drawn into the intake pipe, and the pressure of air drawn into the intake pipe.

18. A method of controlling an air drying system including a plurality of drying devices, comprising:
drawing air into the plurality of drying devices;
discharging the air from each of the plurality of drying devices;
measuring a flow rate of air discharged from each of the plurality of drying devices; and
controlling the flow rate of air discharged from each of the plurality of drying devices to be uniform, based on the measured flow rate of air discharged from each of the plurality of drying devices.

19. The method according to claim 18, wherein
the controlling of the flow rate of air discharged from each of the plurality of drying devices to be uniform comprises controlling opening degrees of a plurality of valves, and
each of the plurality of valves is installed on an exhaust pipe coupled to an exhaust port of each of the plurality of drying devices.

20. The method according to claim 19, further comprising:
determining whether each of the plurality of drying devices has malfunctioned based on the flow rate of air discharged from each of the plurality of drying devices, wherein
in case that one of the plurality of drying devices is determined to have malfunctioned,
one of the plurality of valves installed on the exhaust pipe coupled to the exhaust port of the one of the plurality of drying devices is closed, and
opening degrees of another ones of the plurality of valves are increased.
